(19) United States
(12) Patent Application Publication
(10) Pub. No.: US 2016/0269256 A1
(43) Pub. Date: Sep. 15, 2016

(54) DEPLOYMENT CONTROL METHOD AND DEVICE

(71) Applicant: FUJITSU LIMITED, Kawasaki-shi (JP)

(72) Inventors: Masataka Sonoda, Kawasaki (JP); Jun Ogawa, Kawasaki (JP)

(73) Assignee: FUJITSU LIMITED, Kawasaki-shi (JP)

(21) Appl. No.: 15/044,153

(22) Filed: Feb. 16, 2016

(30) Foreign Application Priority Data
Mar. 13, 2015 (JP) 2015-050812

(51) Int. Cl. H04L 12/26; H04L 29/08

(52) U.S. Cl. CPC H04L 43/08; H04L 67/22

(57) ABSTRACT

A deployment control method includes obtaining, from a storage corresponding to a user system, record information containing a deployment time that was taken for an information processing system to deploy a function corresponding to a deployment request output from the user system and a time of day at which the deployment request was output, calculating a number of deployment requests for each prescribed period of time on the basis of the time of day and the deployment request, and estimating a time taken to deploy the function in response to the number of deployment requests per the prescribed period of time on the basis of the deployment times of the pieces of record information aggregated for each of the numbers of deployment requests.

### CROSS-REFERENCE TO RELATED APPLICATION

This application is based upon and claims the benefit of priority of the prior Japanese Patent Application No. 2015-050812, filed on Mar. 13, 2015, the entire contents of which are incorporated herein by reference.

### FIELD

The embodiments discussed herein are related to a deployment control method and a deployment control device.

### BACKGROUND

There is technology by which a computer system of a cloud service company (referred to as a company system hereinafter) deploys an application program in response to a deployment request to deploy an application program, the request having been obtained from a computer system used by the user (referred to as a user system hereinafter). Hereinafter, the application program may be referred as a program.

As a related art, technology for dynamically selecting a service provider is proposed (for example, Patent Document 1). According to this technology, a service consumer who can use a plurality of service providers dynamically selects a service provider that meets a service level desired for each method that is called when an application program is executed. Also, a cloud service directory provides, in a form of an evaluation table, the evaluation of resource information of each cloud service provider.

[Patent Document 1] Japanese Laid-open Patent Publication No. 2013-89033

### SUMMARY

According to an aspect of the embodiments, a deployment control method includes obtaining, from a storage corresponding to a user system, record information containing a deployment time that was taken for an information processing system to deploy a function corresponding to a deployment request output from the user system and a time of day at which the deployment request was output, calculating a number of deployment requests for each prescribed period of time on the basis of the time of day and the deployment request, and estimating a time taken to deploy the function in response to the number of deployment requests per the prescribed period of time on the basis of the deployment times of the pieces of record information aggregated for each of the numbers of deployment requests.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a system according to an embodiment;

FIG. 2 is a functional block diagram illustrating an example of a virtual system manager;

FIG. 3 is a functional block diagram illustrating an example of an orchestrator;

FIG. 4 illustrates examples of information stored by a request record storage unit;

FIG. 5 illustrates examples of information and a graph stored by an estimated deployment delay storage unit;

FIG. 6 illustrates an example of information stored by a number-of-requests storage unit and a group information storage unit;

FIG. 7 illustrates an example of information stored by a performance index storage unit;

FIG. 8 illustrates a sequence chart explaining an example of a group-joining process;

FIG. 9 is a flowchart illustrating an example of a deployment delay estimation process;

FIG. 10 is a flowchart illustrating an example of estimating a deployment delay;

FIG. 11 is a flowchart illustrating an example of complementing a deployment delay by using an approximation formula;

FIG. 12 is a flowchart illustrating an example of a cloud selection process;

FIG. 13 is a flowchart illustrating an example of a deployment requesting process;

FIG. 14 explains a specific example of the embodiment (first);

FIG. 15 explains a specific example of the embodiment (second);

FIG. 16 explains a specific example of the embodiment (third);

FIG. 17 explains a specific example of the embodiment (fourth);

FIG. 18 explains a specific example of the embodiment (fifth);

FIG. 19 explains a specific example of the embodiment (sixth);

FIG. 20 explains a specific example of the embodiment (seventh);

FIG. 21 explains a specific example of the embodiment (eighth);

FIG. 22 explains a specific example of the embodiment (ninth);

FIG. 23 explains a specific example of the embodiment (tenth);

FIG. 24 explains a specific example of the embodiment (eleventh);

FIG. 25 explains a specific example of the embodiment (twelfth);

FIG. 26 illustrates an example of a system in a variation example;

FIG. 27 is a functional block diagram illustrating an example of a virtual system manager and a general virtual system management in the variation example;

FIG. 28 illustrates an example of information stored by a number-of-requests storage unit and a group information storage unit in the variation example;

FIG. 29 is a flowchart illustrating an example of a cloud selection process in the variation example (first);

FIG. 30 is a flowchart illustrating an example of a cloud selection process in the variation example (second);

FIG. 31 is a flowchart illustrating an example of a deployment requesting process in the variation example;

FIG. 32 explains a specific example of the variation example (first);

FIG. 33 explains a specific example of the variation example (second);

FIG. 34 explains a specific example of the variation example (third);

FIG. 35 explains a specific example of the variation example (fourth);

FIG. 36 explains a specific example of the variation example (fifth);

FIG. 37 explains a specific example of the variation example (sixth);

FIG. 38 explains a specific example of the variation example (seventh);

FIG. 39 explains a specific example of the variation example (eighth);

FIG. 40 illustrates an example of a hardware configuration of a virtual system manager; and

FIG. 41 illustrates an example of a hardware configuration of a general virtual system manager.

### DESCRIPTION OF EMBODIMENTS

When the user system makes a request for a company system to deploy an application program (function), it is desirable that the user recognize the deployment time. However, when the cloud company does not publicize information related to the status of its system, it is difficult for the user to recognize the deployment time for an application program.

### <Example of System According to Embodiment>

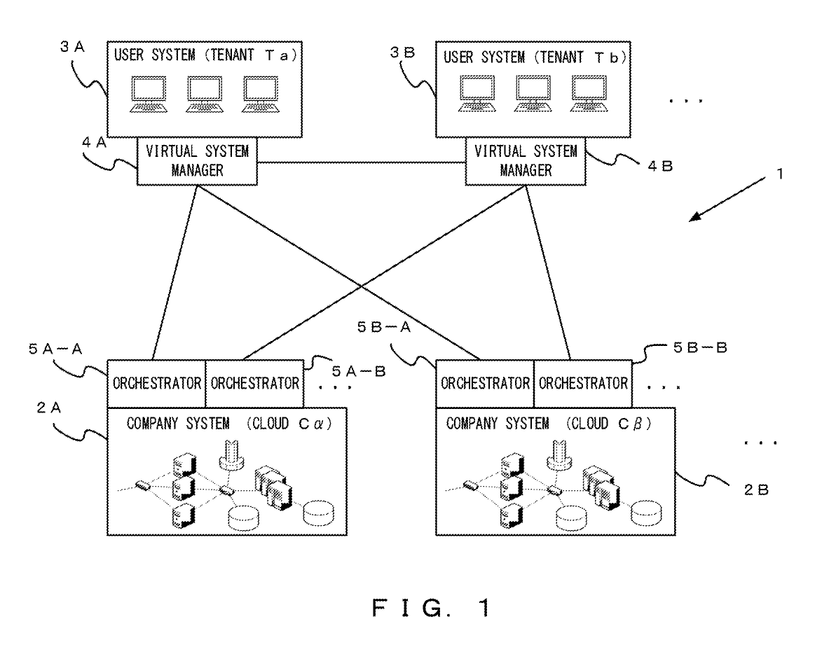

Hereinafter, explanations will be given for the embodiment by referring to the drawings. FIG. 1 illustrates an example of a system 1 according to the embodiment. The system 1 includes a plurality of company systems 2 (2A, 2B, . . . ) and a plurality of user systems 3 (3A, 3B, . . . ).

While the system 1 of the embodiment has the company systems 2 and the user systems 3 in plural, the system 1 may include one company system 2 and one user system 3.

The company system 2 is an information processing system of a company that provides a cloud service to the user system 3. The company system 2 is for example a system including a plurality of servers. Hereinafter, the company system 2 may also be referred to as a cloud.

For example, cloud Cα is an information processing system of the company system 2A, and cloud Cβ is an information processing system of the company system 2B. While the example illustrated in FIG. 1 illustrates two company systems 2, there may be an arbitrary number of the company systems 2. For example, there may be a cloud Cγ.

The user system 3 is a system for a user who uses a cloud service provided by the company system 2. The user system 3 is a computer system including one or a plurality of terminal devices.

In the embodiment, it is assumed that the user systems 3 are systems of a private network in which a plurality of terminal devices are connected to each other. It is also assumed in the embodiment that the user systems 3 are installed in tenant companies. Hereinafter, a tenant company may also be referred to as a tenant.

For example, tenant Ta is a tenant company in which the user system 3A has been installed. Also, tenant Tb is a tenant company in which the user system 3B has been installed. It is assumed that one user system 3 is assigned to one tenant company in the embodiment.

The user systems 3 are not limited to systems installed in tenant companies. When for example a tenant company has a plurality of sections, the user systems 3 may be systems of a private network that is assigned to each of such sections.

Hereinafter, the user system 3 may also be referred to as a tenant. For example, tenant Ta is a tenant company in which the user system 3A has been installed. Also, tenant Tb is a tenant company in which the user system 3B has been installed.

The user system 3 makes a request for the cloud to deploy a function. In the embodiment, it is assumed that a function that the user system 3 requests that the cloud deploy is an application program. The function may be a function that is part of an application program.

As an example, the function whose deployment is requested by the user system 3 is a sales promotion application program. And this application system may be an application system including a Web function, an application program function and a database function.

The user system 3 makes a request for the cloud to deploy an application program. In response to the deployment request to deploy an application program made by the user system 3, the cloud deploys an application program so as to construct a virtual system.

Virtual system managers 4 (4A, 4B, . . . ) are implemented by computers respectively corresponding to the respective user systems 3. When the number of the user systems 3 is one, the number of the virtual system managers 4 is also one. The virtual system managers 4 are an example of a deployment control device.

It is assumed in the embodiment that the virtual system managers 4 are implemented by software installed in some of the computers of the user systems 3. However, the virtual system managers 4 may be implemented by computers connected to the user systems 3.

The virtual system manager 4 receives a deployment request to deploy an application program from the user system 3, and outputs the deployment request to a cloud. The virtual system manager 4 selects one of the plurality of clouds including clouds 2A and 2B. Then, the virtual system manager 4 outputs to the selected cloud the deployment request received from the user system 3.

As illustrated in the example in FIG. 1, the respective virtual system managers 4 communicate with each other. For example, the virtual system manager 4A communicates with other virtual system managers including the virtual system manager 4B.

Orchestrators 5 are devices connected to clouds. The orchestrators 5 are provided for each cloud, convert, in accordance with a prescribed rule, a deployment request input from the virtual system managers 4, and output the deployment request to the cloud.

Each of the orchestrators 5 corresponds to one of the user systems 3. When for example the number of the company systems 2 is C (C is a natural number) and the number of the user systems 3 is U (U is a natural number) in the system 1 for example, the number of the orchestrators 5 in the system 1 is “C×U”.

In the example illustrated in FIG. 1, the orchestrator 5A-A is an orchestrator connected to cloud A and is used for the user system 3A. Also, the orchestrator 5B-A is an orchestrator connected to cloud B and is used for the company system 2A.

When deployment requests to deploy an application program output from a plurality of user systems 3 concentrate on one of the plurality of company systems 2, the loads on the company system 2 on which the deployment requests concentrate increase.

This prolongs the deployment time for the application program used by the company system 2 with the increased loads. In such a case, it is desirable that the user system 3 select the company system 2 with lower loads so as to output a deployment request to the selected company system 2.

However, when the company systems 2 do not publicize the statuses of the clouds, it is difficult for the user systems 3 to select the company system 2 with lower loads. Then, the user system 3 uses the information of the user side so as to select the company system 2 that will complete the deployment of the application program within a permissible time.

### <Example of Virtual System Manager>

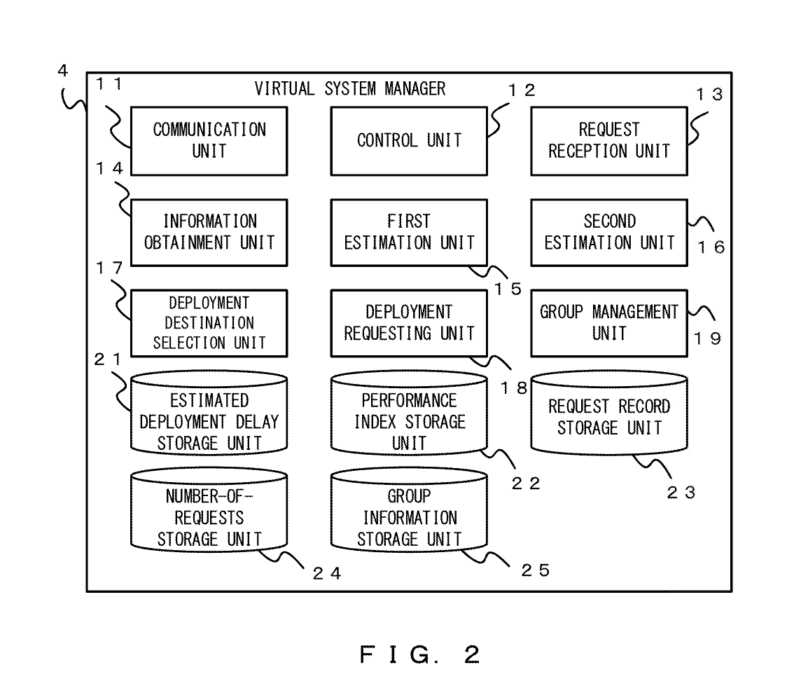

Next, explanations will be given for an example of the virtual system manager 4. FIG. 2 illustrates an example of the virtual system manager 4. The virtual system manager 4 includes a communication unit 11, a control unit 12, a request reception unit 13, an information obtainment unit 14, a first estimation unit 15, a second estimation unit 16, a deployment destination selection unit 17, a deployment requesting unit 18 and a group management unit 19.

Also, the virtual system manager 4 includes an estimated deployment delay storage unit 21, a performance index storage unit 22, a request record storage unit 23, a number-of-requests storage unit 24, and a group information storage unit 25.

The communication unit 11 communicates with other devices. For example, the communication unit 11 communicates with other virtual system managers 4 and with the orchestrators 5 of the respective clouds. The control unit 12 controls various types of operations conducted by the virtual system manager 4.

The request reception unit 13 receives a deployment request to deploy an application program output from the user system 3. The information obtainment unit 14 obtains prescribed information from the virtual system manager 4 of itself and other virtual system managers 4. The information obtainment unit 14 is an example of an obtainment unit.

The first estimation unit 15 estimates a time taken to deploy an application program for each cloud (for each company system 2). The first estimation unit 15 is an example of an estimation unit. The first estimation unit 15 obtains request records of the virtual system manager 4 of itself and other virtual system managers 4.

A request record obtained by the first estimation unit 15 includes the time range in which the virtual system manager 4 made a deployment request and the deployment time taken to deploy the application program corresponding to the deployment request output from the user system 3 (also referred to as a deployment delay hereinafter).

The first estimation unit 15 estimates a time taken to deploy an application program in response to the number of deployment requests per time range. A time range is a period of time between a time of day and another time of day. Respective time ranges are of the same length. A time range is an example of a prescribed period of time.

When there are a plurality of clouds, the first estimation unit 15 estimates a time taken to deploy an application program in response to the number of the deployment requests per time range and for each cloud (also referred to as a deployment delay hereinafter). The first estimation unit 15 stores the estimated deployment delay in the estimated deployment delay storage unit 21.

On the basis of the deployment delay estimated by the first estimation unit 15 and the number of the deployment requests output from the respective virtual system managers 4 in the current time range, the first estimation unit 15 estimates, for each cloud, the deployment delay occurring when an application program is actually deployed in the cloud. A current time range is a time range in which the deployment requesting unit 18 outputs a deployment request.

On the basis of the deployment delay estimated by the second estimation unit 16 for each cloud, the deployment destination selection unit 17 selects a cloud as the destination to which a deployment request to deploy an application program is output. The deployment requesting unit 18 outputs, to the cloud selected by the deployment destination selection unit 17, a deployment request to deploy an application program.

The group management unit 19 manages a group of the user systems 3 in the system 1. One or a plurality of user systems 3 belong to one group. Also, one ID and one communication address are assigned to one group. ID is an abbreviation for identification.

The estimated deployment delay storage unit 21 stores the deployment delay estimated by the first estimation unit 15. The first estimation unit 15 stores an estimated deployment delay in response to the number of the deployment requests regarding each cloud. Accordingly, the estimated deployment delay storage unit 21 stores an estimated deployment delay in response to the number of deployment requests regarding each cloud.

The performance index storage unit 22 stores the performance index of each cloud. In the embodiment, a performance index is determined on the basis of the processing speed of a cloud in deploying an application program and the cost. The request record storage unit 23 stores a request record based on the deployment request output from the virtual system manager 4 of the request record storage unit 23.

The request record is record information related to past deployment requests to deploy an application program made by the virtual system manager 4. Accordingly, the request record storage unit 23 corresponds to the user system 3 that corresponds to the virtual system manager 4. The request record storage unit 23 is an example of a storage unit.

It is assumed in the embodiment that a request record includes information of time of day, an application program, a deployment destination cloud and a deployment delay. Among these pieces of information, information of a time of day is information for identifying a time range.

Information of an application program is information for identifying an application program regarding which the virtual system manager 4 made a deployment request. Information of a deployment destination cloud is information for identifying a cloud to which the virtual system manager 4 output a deployment request.

Information of a deployment delay is information of the above deployment delay. It is assumed in the embodiment that a deployment delay is a period of time between the time of day at which the virtual system manager 4 output a deployment request and the time of day at which the deployment destination cloud has completed the deployment of the application program.

It is assumed in the embodiment that the virtual system manager 4 accesses the cloud to which a deployment request was output so as to recognize the time of day at which the deployment of the application program has been completed. The time at which the deployment of the application program has been completed may be reported to the virtual system manager 4 from the cloud.

For each cloud, the number-of-requests storage unit 24 stores the number of the deployment requests output from the deployment requesting unit 18 in the current time range. Each time the deployment requesting unit 18 outputs a deployment request to a cloud, the deployment requesting unit 18 increments the number of deployment requests corresponding to the cloud to which the deployment request was output.

The number-of-requests storage unit 24 stores the number of deployment requests for each cloud in the current time range. Accordingly, information stored by the number-of-requests storage unit 24 is reset each time the time range changes. The number of requests stored by the number-of-requests storage unit 24 is provided to other virtual system managers 4.

The group information storage unit 25 stores information of the ID to which the user system 3 belongs, the communication address and the belonging-destination tenant. Information of the belonging-destination tenant is information for identifying other user systems 3 that belong to the same group.

### <Example of Orchestrator>

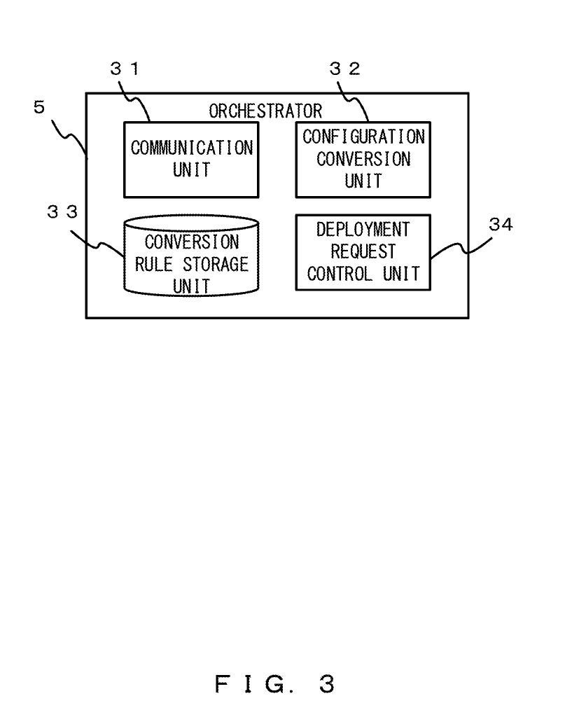

Next, explanations will be given for an example of the orchestrator 5 by referring to FIG. 3. The orchestrator 5 includes a communication unit 31, a configuration conversion unit 32, a conversion rule storage unit 33, and a deployment request control unit 34.

The communication unit 31 communicates with the respective virtual system managers 4. The configuration conversion unit 32 converts a deployment request input from the virtual system manager 4 into a deployment request that is in accordance with the rule of a cloud.

A deployment request output from the virtual system manager 4 to the orchestrator 5 is a versatile request that is not dependent on a cloud. The conversion rule storage unit 33 stores a correspondence relationship between a versatile deployment request output from the virtual system manager 4 and a scheme that is dependent on the company system 2 corresponding to the orchestrator 5.

When the communication unit 31 has input a deployment request, the configuration conversion unit 32 converts the input deployment request into a scheme that is dependent on the company system 2, on the basis of the correspondence relationship stored by the conversion rule storage unit 23. The deployment request control unit 34 outputs to a cloud the deployment request converted by the configuration conversion unit 32.

### <Example of Various Data Configurations>

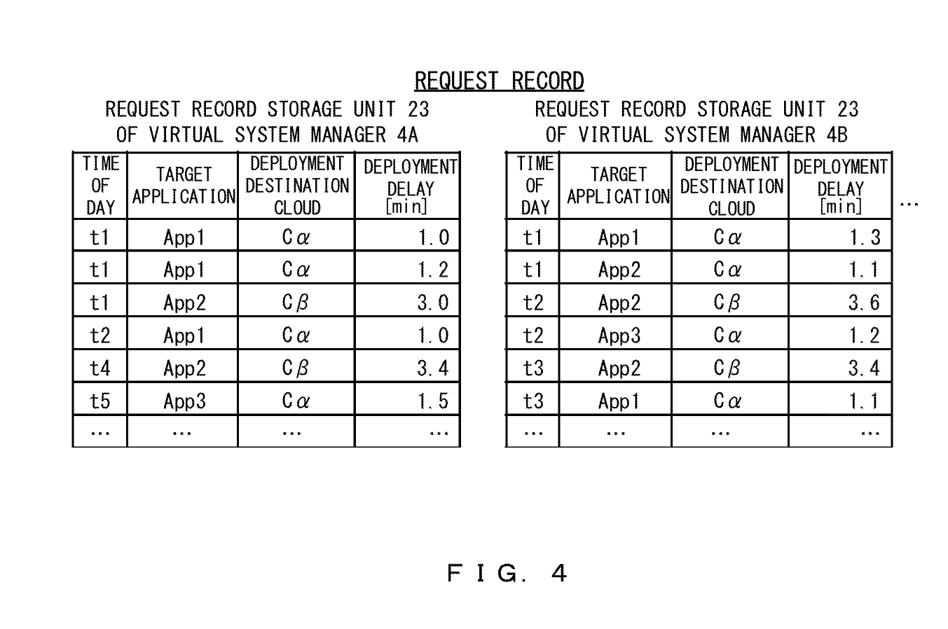

Next, explanations will be given for an example of various data configurations. FIG. 4 illustrates examples of a table stored by the request record storage units 23 of the virtual system manager 4A and the virtual system manager 4B. Each table includes the items for time of day, target application program, deployment destination cloud and deployment delay.

The table in the request record storage unit 23 of the virtual system manager 4A depicts the records of the deployment requests that the virtual system manager 4A output in the past. The table in the request record storage unit 23 of the virtual system manager 4B depicts the records of the deployment requests that the virtual system manager 4B output in the past.

As described above, a time range is a period of time between a time of day and another time of day, and respective time ranges have the same length. In the case of FIG. 4, the time range of time of day t1 is the period of time between time of day t1 and time of day t2, and the time range of time of day t2 is the period of time between time of day t2 and time of day t3.

Hereinafter, it is assumed that there are time ranges up to time of day to (n is an integer equal to or greater than two). In the example illustrated in FIG. 4, the virtual system manager 4A has output three deployment requests in time range of time of day t1 (period of time between time of day t1 and time of day t2). Also, virtual system manager 4B has output two deployment requests in the time range of time of day t1.

When the time range of time of day tn is over, the time range of time t1 emerges again. It is assumed that the period of time between the start of the time range of time of day t1 and the end of the time range of time of day tn is T. As described above, all the time ranges have the same length. Accordingly, the period of time of each time range is a value obtained by dividing period of time T by n above.

One request record corresponds to one deployment request. Accordingly, each time the deployment requesting unit 18 outputs a deployment request, the deployment requesting unit 18 stores a request record in the request record storage unit 23.

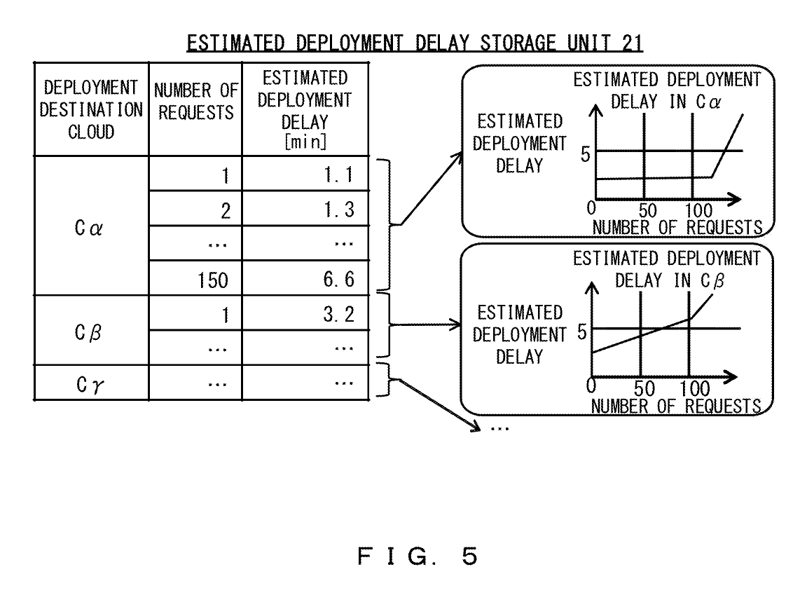

FIG. 5 illustrates examples of a table (information) and a graph stored by the estimated deployment delay storage unit 21. The table in FIG. 5 includes the items for deployment destination cloud, number of requests and estimated deployment delay.

Regarding each cloud, the first estimation unit 15 estimates the deployment delay in accordance with the number of deployment requests per time range. The estimated deployment delay storage unit 21 stores the deployment delay estimated by the first estimation unit 15 (estimated deployment delay) for each cloud and for each of the numbers of deployment requests. In and subsequent to FIG. 5, the number of deployment requests is referred to as the number of requests.

The number of deployment requests per time range is equal to the number of deployment requests output from the virtual system manager 4 in one time range (=T/n). For example, the number of deployment requests per time range may be the number of deployment requests per unit time.

For example, the case illustrated in FIG. 5 illustrates that when the number of deployment requests made for cloud Cα by the virtual system manager 4 per time range is one, the estimated deployment delay is 1.1 min.

Also, the case illustrated in FIG. 5 illustrates that when the number of deployment requests made for cloud Cα by the virtual system manager 4 per time range is 150, the estimated deployment delay is 6.6 min.

When the virtual system manager 4 outputs many deployment requests to a cloud per time range, the loads on the cloud increases. Increased loads on a cloud prolongs the estimated deployment delay.

The graphs illustrated in FIG. 5 illustrate estimated deployment delays based on the values in the table of the estimated deployment delay storage unit 21. The horizontal axes represent numbers of deployment requests (the number of requests) per time range. The number of deployment requests per time range can also be considered to be the frequency of deployment requests. The vertical axes represent estimated deployment delays.

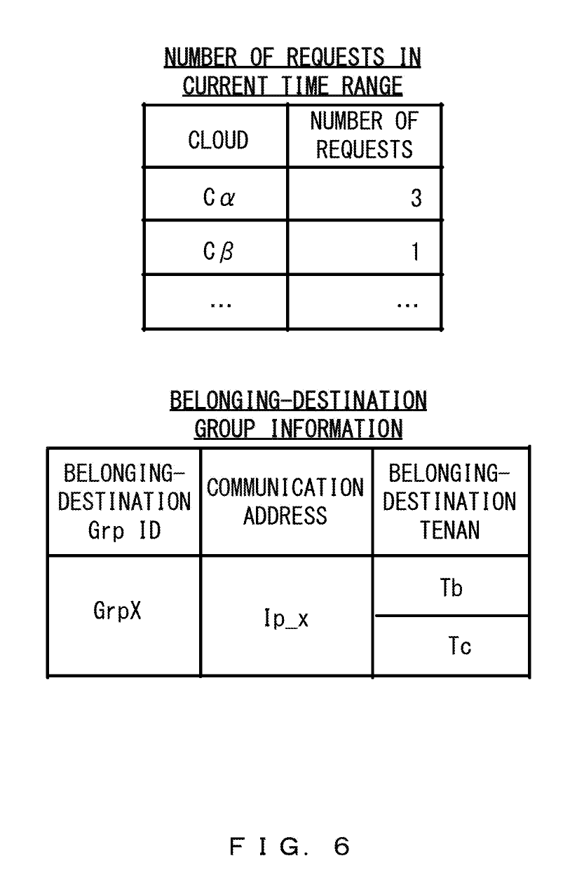

FIG. 6 illustrates an example of tables of the number of deployment requests and belonging-destination group information in the current time range. The number of deployment requests in the current time range is stored by the number-of-requests storage unit 24. Belonging-destination group information is stored by the group information storage unit 25.

The deployment requesting unit 18 outputs to the cloud selected by the deployment destination selection unit 17 a deployment request to deploy an application program. Outputting the deployment request, the deployment requesting unit 18 increments the number of deployment requests for each cloud in the number-of-requests storage unit 24.

In the example illustrated in FIG. 6, the number of deployment requests output to cloud Cα from the deployment requesting unit 18 in the current time range is three, and the number of deployment requests output to cloud Cβ is one. Each time the deployment requesting unit 18 outputs a deployment request, the deployment requesting unit 18 increments the value corresponding to the deployment destination cloud.

Belonging-destination group information is information of a group to which the virtual system manager 4 of itself belongs. A table of belonging-destination group information includes a belonging-destination group ID, a communication address, and a belonging-destination tenant.

Belonging-destination group ID is an identifier for identifying a group to which the tenant corresponding to the virtual system manager 4 belongs. Communication address represents a communication address assigned to a group. Belonging-destination tenant represents a tenant belonging to the same group.

A communication address may be for example an Internet Protocol (IP) address. Information of a tenant is information for identifying a tenant. Because a tenant corresponds to the user system 3, information of a tenant is also information for identifying the user system 3.

In the case of FIG. 6, a communication address Ip_X is assigned to group X (GrpX). Also, tenants Tb and Tc belong to group X. In other words, the user systems 3B and 3C belong to group X.

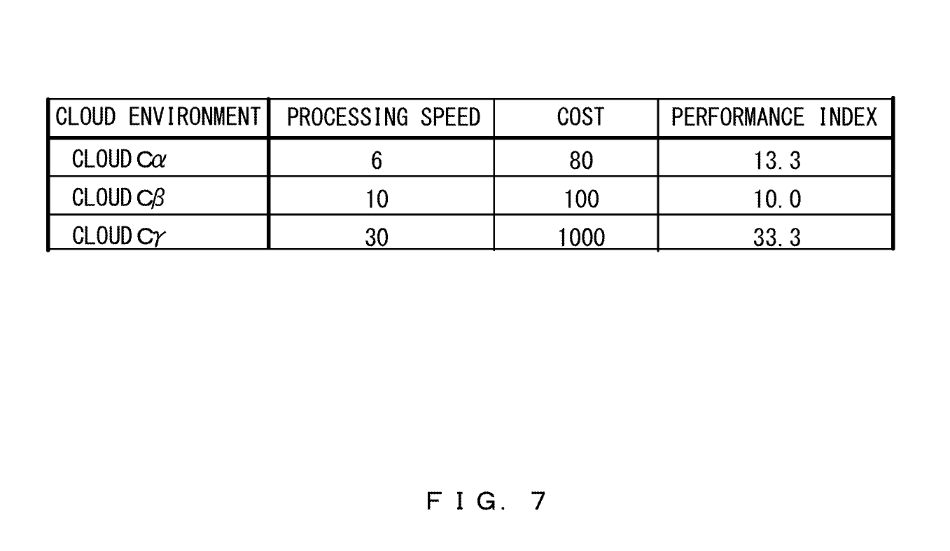

FIG. 7 illustrates an example of a table stored by the performance index storage unit 22. As illustrated in the example in FIG. 7, the table of the performance index storage unit 22 includes the items for cloud environment, processing speed, cost and performance index.

Cloud environment is information for identifying a cloud. Respective clouds may be used virtual machines of the same type and may also be used virtual machines of different types. Processing speed represents the number of deployment requests processed by a corresponding cloud per second. Cost represents a fee for using for example a cloud. Performance index is a value resulting from dividing the process speed by the cost.

For cloud Cα for example, the processing speed is 6 and the cost is 80. Accordingly, the performance index is 13.3. The lower the value of a performance index is, the higher the performance of the corresponding cloud is. Accordingly, in the case of the example illustrated in FIG. 7, cloud Cβ is the cloud with the highest performance.

### <Example of Process in Embodiment>

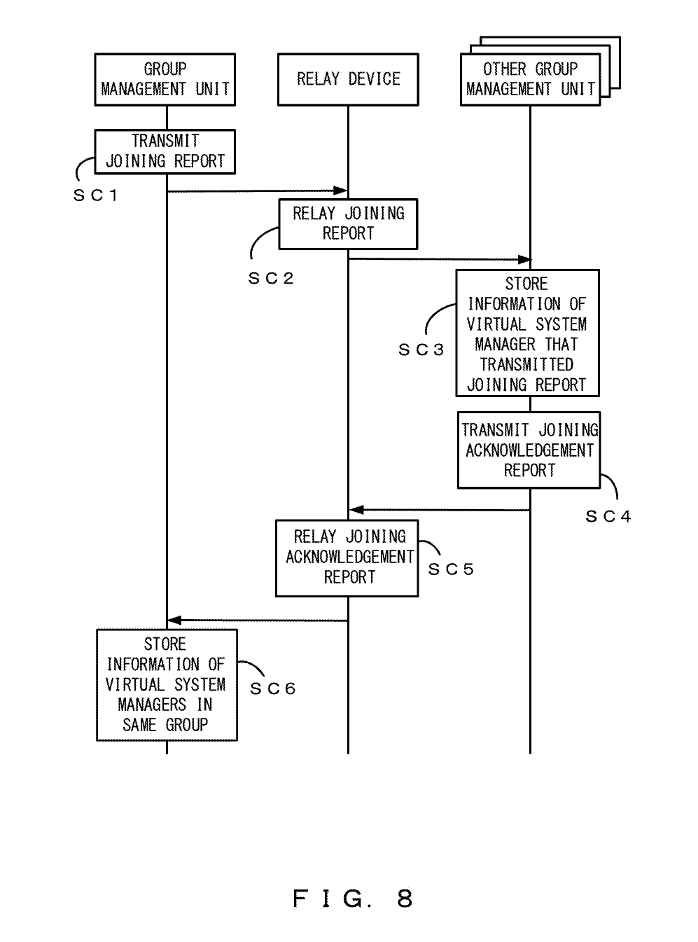

Next, explanations will be given for an example of a process in the embodiment. FIG. 8 illustrates a sequence chart explaining an example of a group-joining process. When the virtual system manager 4 belongs to one of the groups of the system 1, the group management unit 19 conducts control of outputting a joining report to a relay device (not illustrated). The communication unit 11 outputs the joining report to the relay device (step SC11).

The relay device may be for example a multicast router. The relay device outputs, in a multicast manner, a joining report to one or a plurality of virtual system managers 4 on the basis of the communication address of the group specified by the joining report (step SC2).

The group management unit 19 of each virtual system manager 4 that has input a joining report stores, in the group information storage unit 25, information of the virtual system manager 4 that output the joining report (step SC3).

Thereafter, the group management unit 19 of each virtual system manager 4 that has input the joining report controls the communication unit 11 so that a joining acknowledgement report is output to the virtual system manager 4 that output the joining report. Each communication unit 11 outputs the joining acknowledgement report to the relay device (step SC4).

The relay device relays the joining acknowledgement report (step SC5). The communication unit 11 of the virtual system manager 4 that output the joining report inputs the joining acknowledgement report. Thereby, the virtual system manager 4 having output the joining report stores information of the virtual system managers 4 in the same group (step SC6).

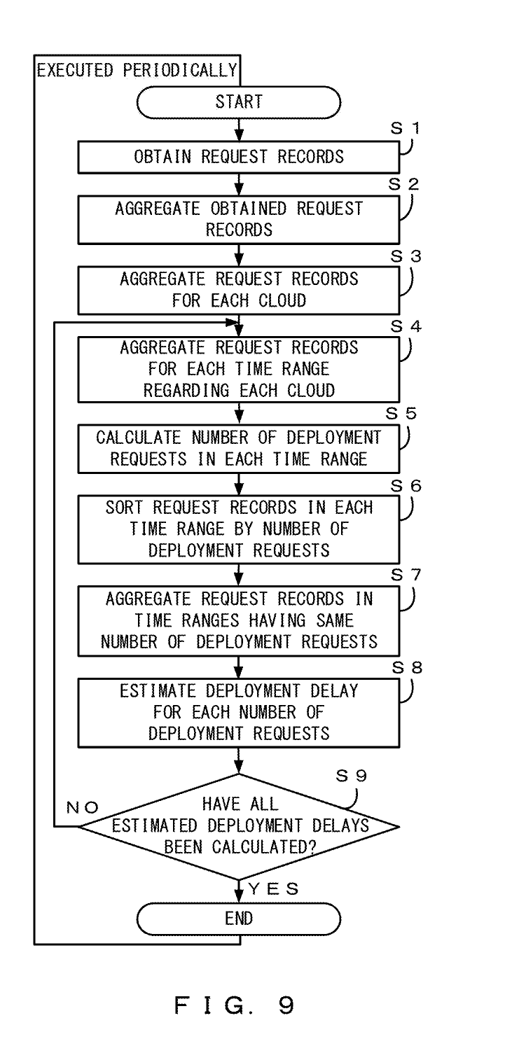

Next, explanations will be given for an example of a deployment delay estimation process by referring to the flowchart illustrated in FIG. 9. The information obtainment unit 14 obtains a request record stored in the request record storage unit 23 of each virtual system manager 4 belonging to the same group (step S1).

The information obtainment unit 14 obtains a request record stored in the request record storage unit 23 of one or a plurality of other virtual system managers 4 in the same group. Also, the information obtainment unit 14 obtains a request record stored in the request record storage unit 23 of the virtual system manager 4 of the information obtainment unit 14.

The first estimation unit 15 aggregates the obtained request records for each tenant (step S2). Then, the first estimation unit 15 aggregates the request records for each company system 2 (for each cloud) (step S3).

The first estimation unit 15 aggregates request records to each cloud for each time range (step S4). As described above, a request record includes a time range. The first estimation unit 15 aggregates request records for each time range regarding each cloud.

The first estimation unit 15 calculates the number of request records for each time range regarding each cloud (step S5). The number of request records to each cloud for each time range is the number of deployment requests to each cloud for each time range. Accordingly, the first estimation unit 15 calculates the number of request records for each time range so as to calculate the number of deployment requests for each time range regarding each cloud.

In step S4, the first estimation unit 15 aggregates request records for each time range regarding each cloud. The first estimation unit 15 sorts, by the calculated number of deployment requests, the request records aggregated for each time range regarding each cloud (step S6).

The request records have been aggregated for each time range. The first estimation unit 15 aggregates request records in time ranges having the same number of deployment requests (step S7). Thereby, the request records are aggregated for each of the numbers of deployment requests in one time range regarding each cloud.

The first estimation unit 15 estimates the deployment delay regarding each cloud on the basis of the request records aggregated for each of the numbers of deployment requests (step S8). A request record includes information of a past deployment delay.

For example, the first estimation unit 15 may conduct an arbitrary statistical process on past deployment delays aggregated for each of the numbers of deployment requests so as to estimate the deployment delay for each of the numbers of deployment requests. Accordingly, the first estimation unit 15 obtains the estimated deployment delay for each of the numbers of deployment requests regarding each cloud.

The first estimation unit 15 stores the estimated deployment delay in response to the number of deployment requests in the estimated deployment delay storage unit 21 regarding each cloud. Thereby, the table illustrated in FIG. 5 is stored in the estimated deployment delay storage unit 21 illustrated in FIG. 5 for example.

The first estimation unit 15 determines whether all estimated deployment delays have been calculated (step S9). In other words, the first estimation unit 15 determines whether all estimated deployment delays in response to the numbers of deployment requests have been calculated regarding each cloud.

When the first estimation unit 15 has not calculated all estimated deployment delays (NO in step S9), the processes from step S4 through step S8 are performed. When the first estimation unit 15 has calculated all estimated deployment delays (YES in step S9), the deployment delay estimation process is terminated.

The first estimation unit 15 periodically executes a deployment delay estimation process. When a deployment delay estimation process has been terminated, the first estimation unit 15 may reset information stored in the estimated deployment delay storage unit 21. For this resetting, the first estimation unit 15 may save information stored in the estimated deployment delay storage unit 21 to an arbitrary storage device.

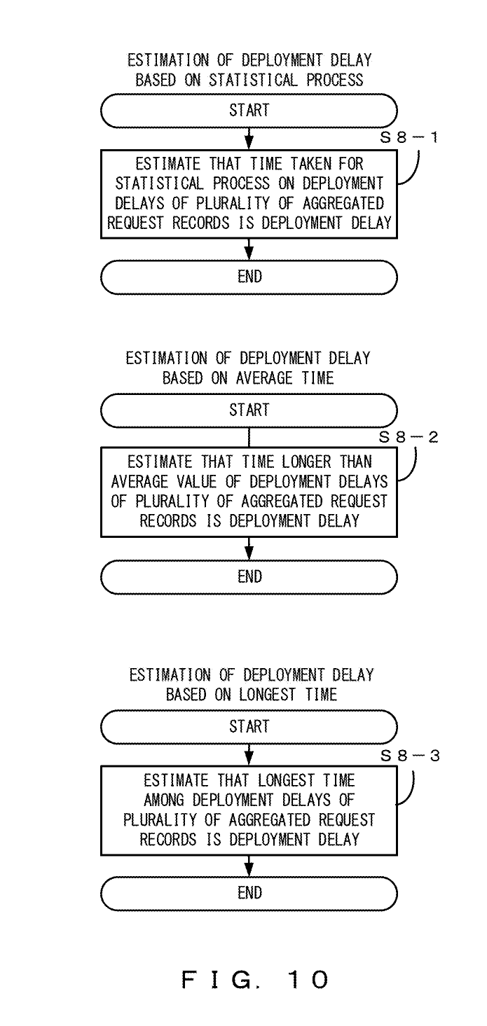

The first estimation unit 15 estimates the deployment delay of each cloud on the basis of the deployment delays of the request records aggregated for each of the numbers of deployment requests and regarding each cloud. As described by “estimation of deployment delay based on statistical process” appearing in FIG. 10, the first estimation unit 15 may conduct a statistical process on deployment delays included in the aggregated request records. Also, the first estimation unit 15 may estimate that the time taken for the statistical process is the deployment delay (step S8-1).

As described by “estimation of deployment delay based on average time” appearing in FIG. 10, the first estimation unit 15 may estimate that a time longer than the average value of the deployment delays included in the plurality of aggregated request records is the deployment delay (step S8-2).

Also, as described by “estimation of deployment delay based on longest time” appearing in FIG. 10, the first estimation unit 15 may estimate that the longest time among the deployment delays included in the plurality of aggregated request records is the deployment delay (step S8-3).

As described above, in step S7, the first estimation unit 15 aggregated the request records in time ranges having the same number of deployment requests. Regarding such aggregation, there may be a case where the number of requests without request records emerges. An example is a case where the number of deployment requests per time range is four and there are no request records.

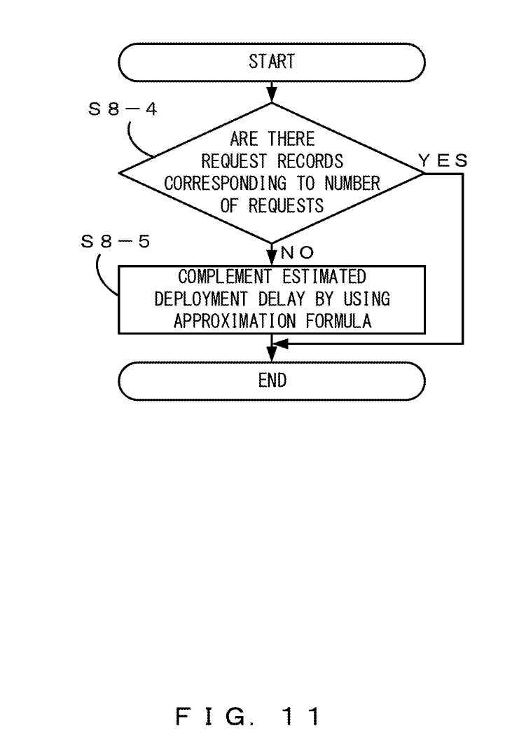

In such a case, as illustrated in the example in FIG. 11, the first estimation unit 15 determines whether there are request records corresponding to the number of deployment requests (number of requests) (step S8-4). When there are not request records corresponding to the number of deployment requests (NO in step S8-4), the first estimation unit 15 performs complementation by using an approximation formula (step S8-5).

Specifically, the first estimation unit 15 conducts approximation by using an approximation formula on the estimated deployment delay in response to a different number of deployment requests with request records so as to complement the estimated deployment delay in response to the number of deployment requests. When there are request records corresponding to the number of deployment requests (YES in step S8-4), the process in step S8-5 is not conducted.

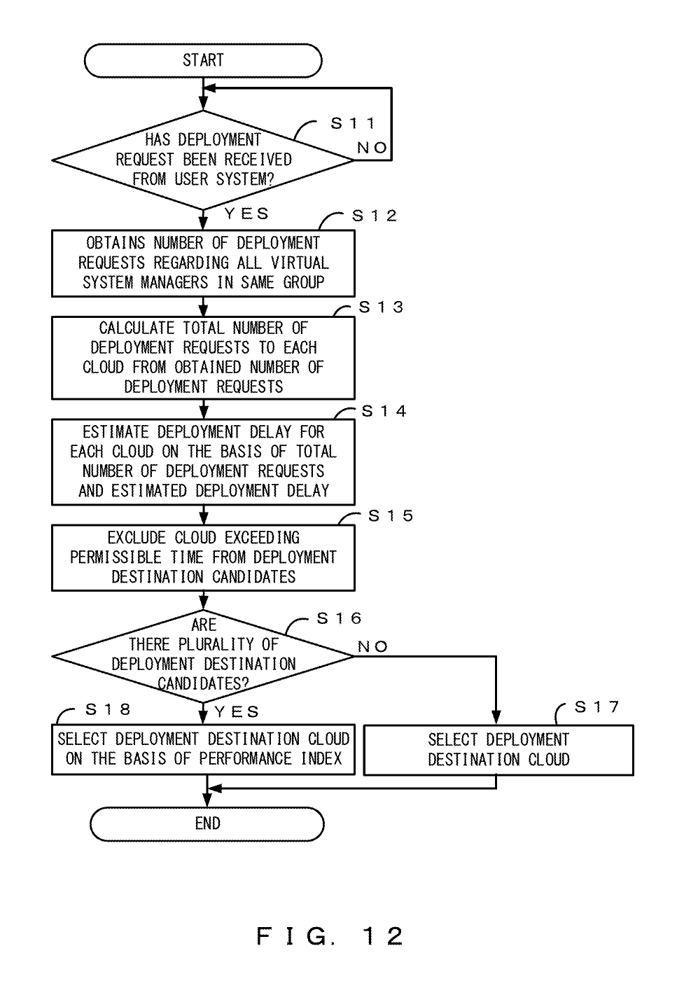

Next, explanations will be given for an example of a cloud selection process by referring to the flowchart illustrated in FIG. 12. The request reception unit 13 determines whether a deployment request has been received from the user system 3 (step S11).

When the request reception unit 13 has not received a deployment request from the user system 3 (NO in step S11), the process does not proceed to the next step. When the request reception unit 13 has received a deployment request from the user system 3 (YES in step S11), the process proceeds to the next step.

The information obtainment unit 14 obtains the number of deployment requests to each cloud in the current time range regarding all the virtual system managers 4 in the same group (step S12). The number of deployment requests to each cloud is stored by the number-of-requests storage unit 24. Accordingly, the information obtainment unit 14 obtains information of the number-of-requests storage units 24 of all the virtual system managers 4 in the same group.

The second estimation unit 16 adds the obtained numbers of deployment requests so as to calculate the total number of deployment requests to each cloud in the current time range (step S13). In the estimated deployment delay storage unit 21, the estimated deployment delay in response to the number of deployment requests is stored regarding each cloud.

The second estimation unit 16 refers to the estimated deployment delay storage unit 21 so as to estimate the deployment delay for each cloud in response to the total number of deployment requests calculated in step S13 (step S14). In other words, the second estimation unit 16 obtains the deployment delay corresponding to the above total number of deployment request from the estimated deployment delay storage unit 21 for each cloud.

A candidate for a deployment destination cloud for an application program is referred to as a deployment destination candidate. In the embodiment, a deployment request includes a permissible time that is a time permitted by the user system 3 for deploying an application program. A deployment request indicates that it is requested that the deployment of an application program be completed within a permissible time.

From among the deployment destination candidates, the deployment destination selection unit 17 excludes a cloud for which a deployment delay has exceeded a permissible time among the deployment delays of the respective clouds (step S15). Thereby, clouds as deployment destination candidates are narrowed.

The deployment destination selection unit 17 determines whether there are a plurality of clouds as deployment destination candidates after being narrowed (step S16). When there is one cloud that is a deployment destination candidate (NO in step S16), the deployment destination selection unit 17 selects that cloud as the deployment destination for the application program (step S17).

When there are a plurality of clouds that are deployment destination candidates (YES in step S16), the deployment destination selection unit 17 selects one of the plurality of clouds as the deployment destination for the application program on the basis of the performance index (step S18).

The deployment destination selection unit 17 refers to the performance index storage unit 22. The performance index storage unit 22 stores a performance index for each cloud. The deployment destination selection unit 17 may select, as the deployment destination for an application program, the cloud with the best performance index among a plurality of clouds as deployment destination candidates (the cloud with the lowest value of the performance index in the embodiment).

As described above, a performance index is an index determined on the basis of the processing speed and cost of a cloud. Accordingly, it is also possible to select one of a plurality of clouds that are deployment destination candidates on the basis of the processing speeds and costs of the clouds.

Also, the deployment destination selection unit 17 may select the cloud with the highest processing speed from among a plurality of clouds that are deployment destination candidates. Thereby, the deployment destination cloud completes the deployment of an application program the most speedily.

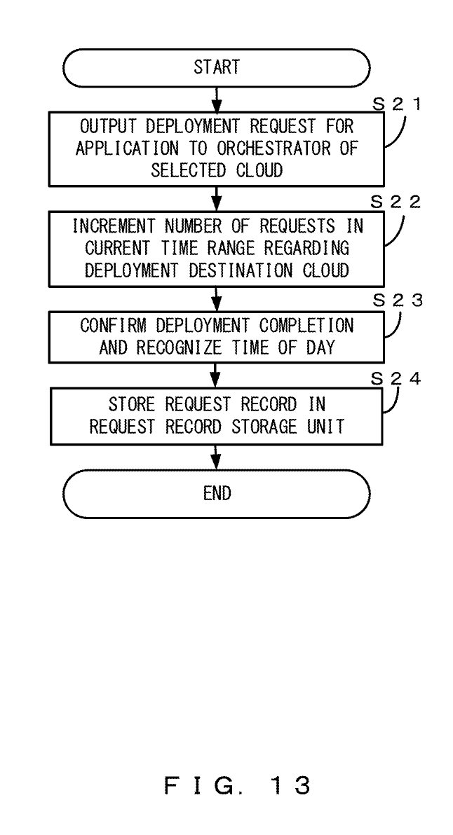

Next, explanations will be given for an example of a deployment requesting process by referring to the flowchart illustrated in FIG. 13. The deployment requesting unit 18 outputs a deployment request to deploy an application program to the orchestrator 5 corresponding to the cloud selected in the cloud selection process, the request having been input from the user system 3 (step S21).

In the current time range, the virtual system manager 4 outputs a deployment request to the orchestrator 5 corresponding to the selected cloud. Accordingly, the deployment requesting unit 18 increments the number of deployment requests corresponding to the selected cloud in the table stored in the number-of-requests storage unit 24 (step S22).

The control unit 12 controls the communication unit 11 so as to access the cloud to which the deployment request was output, confirms the completion of the deployment of the application program, and recognizes the time of day at which the deployment was completed (step S23).

The control unit 12 has recognized the time of day at which the deployment request was output, the application program to be deployed, and the deployment destination cloud. Also, the control unit 12 recognizes the deployment delay on the basis of the time of day at which the deployment request was output and the time of day at which the deployment was completed. The control unit 12 stores the request record based on each piece of information in the request record storage unit 23 (step S24).

### Specific Example of Embodiment

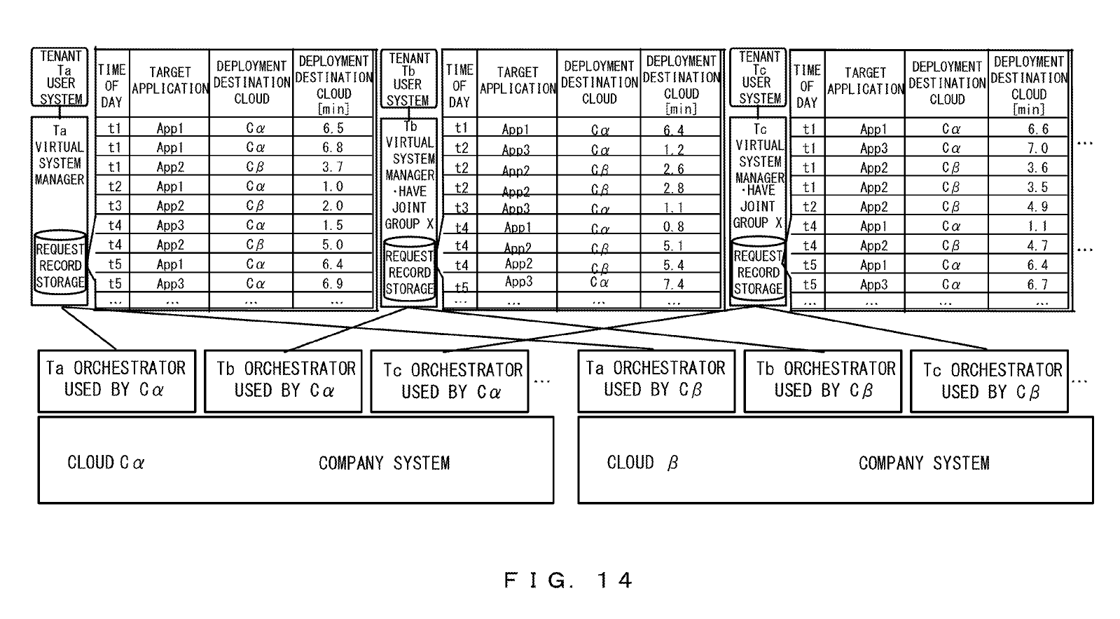

Next, a specific example of the embodiment will be explained. FIG. 14 illustrates the system 1 in the specific example. The system 1 includes clouds Cα and Cβ as the company systems 2. Also, the system 1 includes a plurality of user systems 3 (tenants Ta, Tb, Tc, . . . ).

The virtual system manager 4A is the virtual system manager 4 of tenant Ta. The virtual system manager 4B is the virtual system manager 4 of tenant Tb. The virtual system manager 4C is the virtual system manager 4 of tenant Tc.

In and subsequent to FIG. 14, the virtual system manager 4A is referred to as the Ta virtual system manager. Also, the virtual system manager 4B and the virtual system manager 4C are referred to as the Tb virtual system manager and the Tc virtual system manager, respectively.

The orchestrator 5 is provided for each tenant regarding each of the clouds. In the case of the example illustrated in FIG. 14 for example, the Ta orchestrator used by Cα is the orchestrator 5 regarding Cα and for tenant Ta.

As illustrated in the example in FIG. 14, the request record storage unit 23 stores a target application program of a deployment request, a deployment destination cloud, and a deployment delay for each time range on the basis of a deployment request in each time range.

Also, in the example illustrated in FIG. 14, tenant Tb and tenant Tc have joined group X. In other words, tenants Tb and Tc belong to group X. Tenant Ta does not belong to group X.

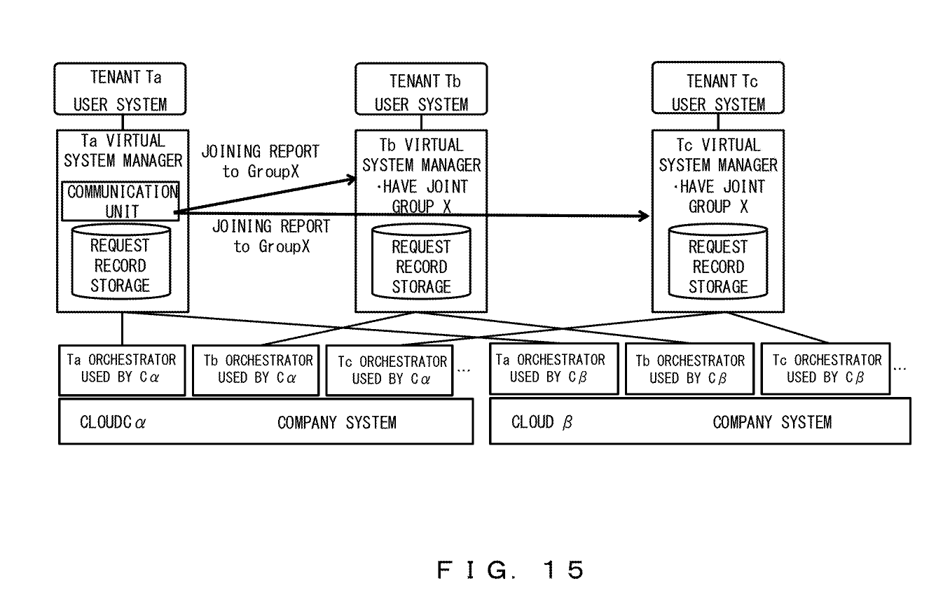

A case is assumed where the virtual system manager 4A joins group X. In such a case, as illustrated in the example in FIG. 15, the virtual system manager 4A outputs, in a multicast manner, a joining report to the other virtual system managers 4 belonging to group X.

The other virtual system managers 4 that have input the joining report store information of the virtual system manager 4A in the group information storage units 25. The other virtual system managers 4 having input the joining report output a joining acknowledgement report to the virtual system manager 4A.

The virtual system manager 4A stores, in the group information storage unit 25, information of the other virtual system managers 4 belonging to group X. The virtual system manager 4A recognizes the virtual system manager 4B and the virtual system manager 4C, and the virtual system managers 4B and 4C recognize the virtual system manager 4A. Thus, the virtual system manager 4A belongs to group X.

It is assumed that the virtual system manager 4A has received a deployment request to deploy an application program from the user system 3A (tenant Ta). In step S1 illustrated in FIG. 9, the information obtainment unit 14 obtains the request records stored in the request record storage units 23 of the other virtual system managers 4 belonging to group X.

In step S2, the first estimation unit 15 of the virtual system manager 4A aggregates, for each tenant, the request records obtained by the information obtainment unit 14. Thereafter, in step S3, the first estimation unit 15 aggregates the request records for each cloud.

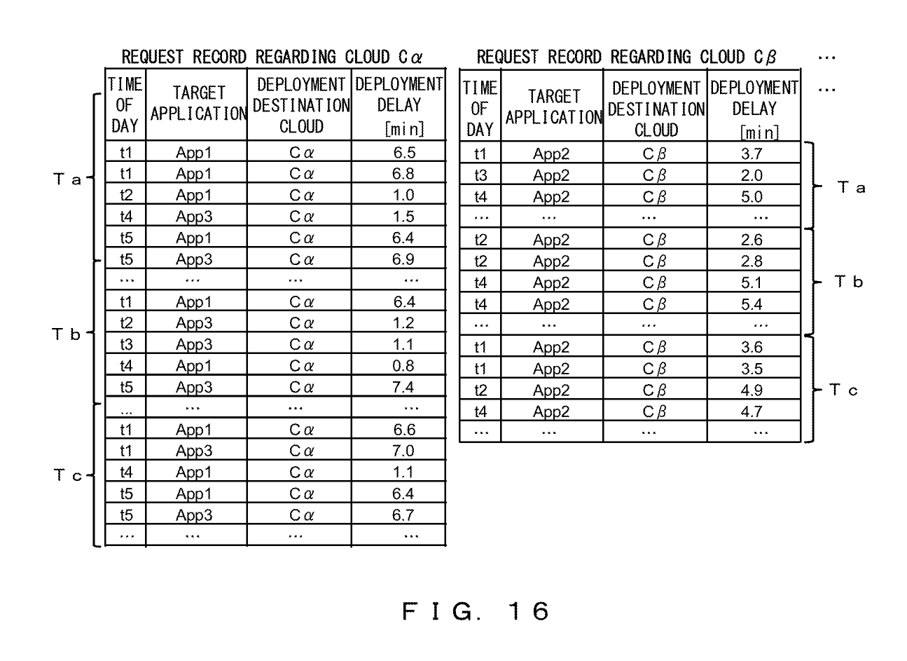

FIG. 16 illustrates an example in which the first estimation unit 15 aggregated request records for each tenant regarding each cloud. The request records of cloud Cα represent the records of deployment requests output from each tenant in group X to cloud Cα.

As illustrated in the example in FIG. 16, among the request records to cloud Cα, the request records are aggregated for each tenant. Also, among the request records to cloud Cβ, the request records are aggregated for each tenant.

The first estimation unit 15 aggregates the request records for each time range regarding each cloud in step S4. In the example illustrated in FIG. 16 for example, the virtual system manager 4A corresponding to tenant Ta has output two deployment requests in the time range of time of day t1.

In the same time range, the virtual system manager 4B corresponding to tenant Tb has output one deployment request. In the same time range, the virtual system manager 4C corresponding to tenant Tc has output two deployment requests.

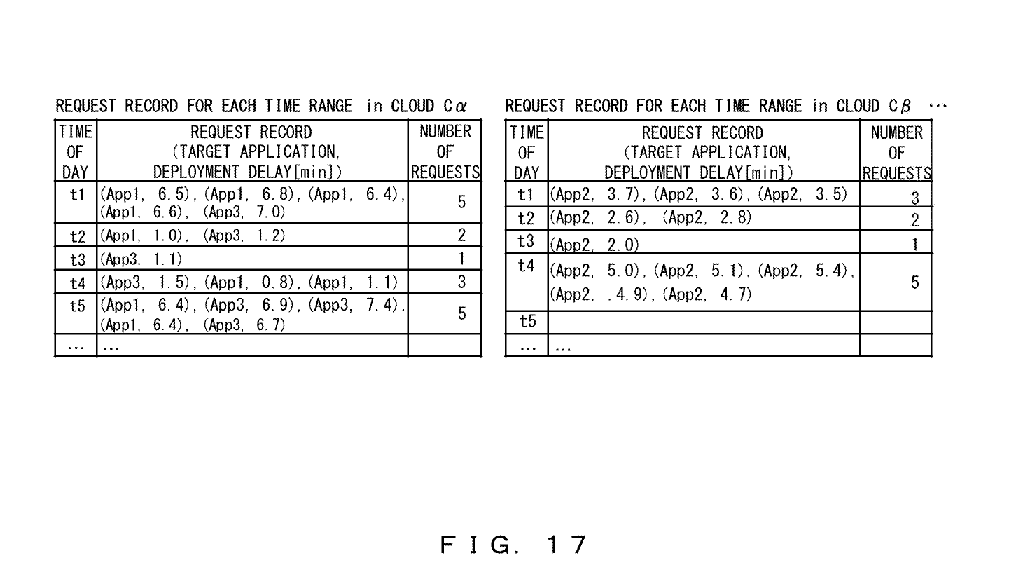

FIG. 17 illustrates examples of request records aggregated for each time range and regarding each cloud. In step S5, the first estimation unit 15 calculates, for each time range, the number of deployment requests to each cloud.

In the case of the example in FIG. 17, five deployment requests have been output to cloud Cain the time range of time of day t1. The first estimation unit 15 calculates the number of deployment requests for each time range and regarding each cloud.

In step S6, the first estimation unit 15 sorts the request records in each time range by the number of deployment requests. Then, the first estimation unit 15 aggregates the request records in time ranges having the same number of requests.

For example, the number of deployment requests in the time range of t1 is five and the number of deployment requests in the time range of time of day t5 is also five. Accordingly, the first estimation unit 15 aggregates the request records in the time range of time of day t1 and the request records in the time range of time of day t5.

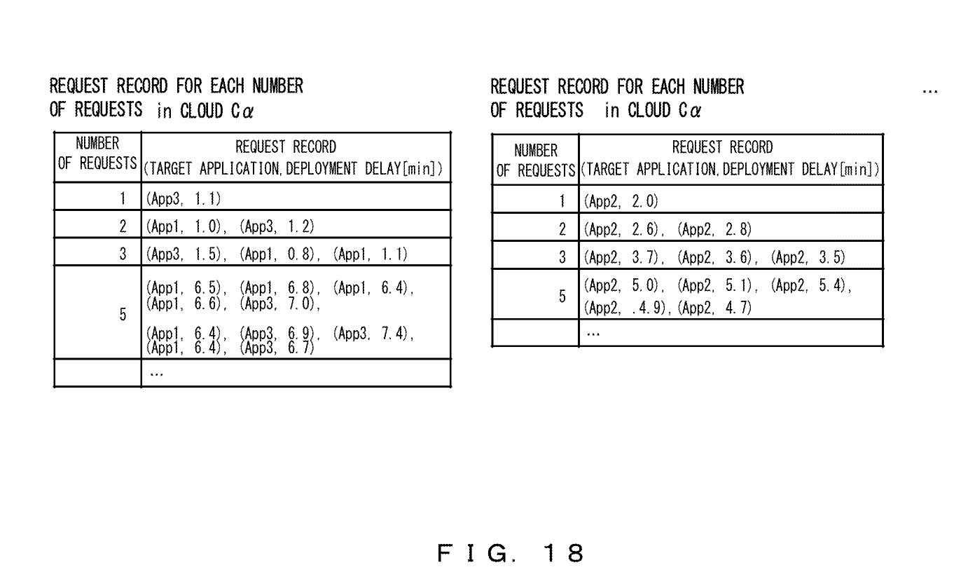

Thereby, as illustrated in the example in FIG. 18, the request records for each of the numbers of deployment requests and regarding each cloud are obtained. The number of deployment requests (number of requests) in the example illustrated in FIG. 18 is the number of deployment requests per time range.

A request record includes information of a deployment delay. The first estimation unit 15 estimates the deployment delay for each of the numbers of deployment requests on the basis of the deployment delays of the request records aggregated for each of the numbers of deployment requests regarding each cloud.

When the number of request records corresponding to the number of deployment requests is one, the first estimation unit 15 treats the deployment delay of that request record as an estimated deployment delay. When there are a plurality of request records that correspond to the number of deployment requests, the first estimation unit 15 obtains an estimated deployment delay on the basis of the deployment delays of the plurality of request records.

In the embodiment, the first estimation unit 15 conducts a statistical process on a plurality of deployment delays so as to obtain an estimated deployment delay for each of the numbers of deployment requests. In the case of the example illustrated in FIG. 18 for example, the number of request records corresponding to the case where the number of deployment requests is five is ten.

The first estimation unit 15 may treat the average value of ten deployment delays as an estimated deployment delay. However, it is desired that an estimated deployment delay be a value greater than the average value of the deployment delays included in the request records.

As described above, the first estimation unit 15 excludes a cloud for which the estimated deployment delay has exceeded a permissible time from among deployment destination candidates. Accordingly, a small value of an estimated deployment delay narrows the scope of clouds to be selected by the first estimation unit 15.

Accordingly, the first estimation unit 15 treats as an estimated deployment delay a value greater than the average value of the deployment delays included in the request records. In the embodiment, the 95-percentile value of the deployment delays of a plurality of request records for each of the numbers of deployment requests is treated as an estimated deployment delay.

As described above, it is also possible for the first estimation unit 15 to treat as an estimated deployment delay the longest deployment delay among the deployment delays of a plurality of request records for each of the numbers of deployment requests. In such a case, the scope of targets for the first estimation unit 15 to select a cloud becomes the largest.

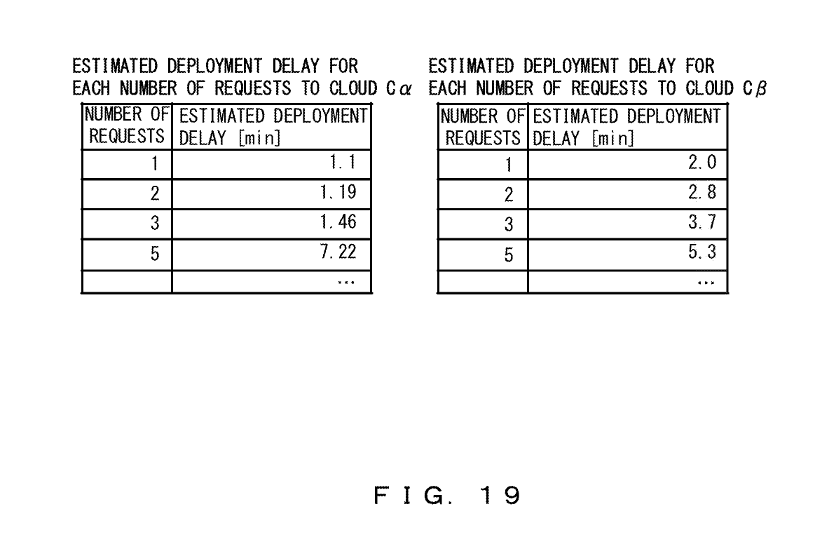

FIG. 19 illustrates an example in which the first estimation unit 15 uses the 95-percentile value to calculate estimated deployment delays for each of the numbers of deployment requests and regarding each cloud. In the examples illustrated in FIG. 18, neither cloud Cα nor cloud Cβ has an estimated deployment delay corresponding to a case where the number of deployment requests is four.

This is because none of the virtual system managers 4 belonging to group X has a time range in which four deployment requests were output. Request records for each of the numbers of deployment requests are based on the records of the respective virtual system managers 4 outputting deployment requests in the past. Accordingly, some cases have no request records corresponding to the number of deployment requests.

Then, the first estimation unit 15 complements an estimated deployment delay corresponding to the number of deployment requests. In the embodiment, the first estimation unit 15 complements an estimated deployment delay corresponding to the number of deployment requests by using an approximation formula.

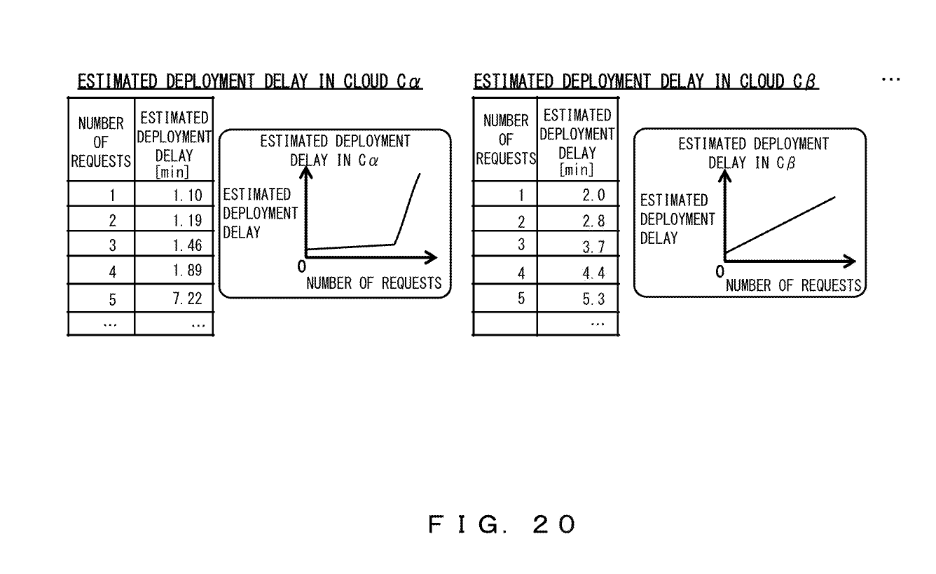

FIG. 20 illustrates examples in which the first estimation unit 15 uses an approximation formula to complement the estimated deployment delays corresponding to a case where the number of deployment requests is four. Thereby, the first estimation unit 15 stores, in the estimated deployment delay storage unit 21, an estimated deployment delay in response to each of the numbers of deployment requests regarding each cloud. The graphs illustrated in FIG. 20 represent the relationship between the numbers of requests and estimated deployment delays.

Through the above processes, the first estimation unit 15 estimates the deployment delay in response to the number of deployment requests per time range. The information obtainment unit 14 obtains request records from the request record storage units 23 of the virtual system managers 4 belonging to the same group, and the first estimation unit 15 estimates the deployment delay in response to the number of deployment requests regarding each cloud on the basis of the obtained request records.

Accordingly, the virtual system manager 4 can estimate the deployment delay in response to the number of deployment requests regarding each cloud without obtaining information on the statuses of the clouds (company systems 2).

Accordingly, the virtual system manager 4 can estimate a deployment delay on the basis of the information of request records obtained from the plurality of virtual system managers 4 even when the cloud (company system 2) does not publicize such information.

A case is now assumed where the number of the company systems 2 is one and the number of the user systems 3 is also one. In such a case, the virtual system manager 4 performs the above processes on the basis of the record information stored in itself, and thereby can estimate the deployment delay of an application program of the company system 2.

Accordingly, even when the numbers of the company systems 2 and the user systems 3 are both one, the virtual system manager 4 can estimate the deployment delay of an application program of the company system 2 without obtaining the information on the status of the company system 2.

Also, the system 1 may include one company system 2 and a plurality of user systems 3. The virtual system manager 4 performs the above processes on the basis of the record information stored in itself and in the other virtual system managers 4, and thereby can estimate the deployment delay of an application program of the company system 2.

In such a case, the virtual system manager 4 uses not only the record information of itself but also record information of the other virtual system managers 4 so as to estimate the deployment delay of an application program. Accordingly, the deployment delay of an application program can be estimated on the basis of more record information, increasing the estimation accuracy.

Next, explanations will be given for an example where when the virtual system manager 4A has received a deployment request to deploy an application program from the user system 3A, the virtual system manager 4A deploys an application program in one of the clouds.

It is assumed that the user system 3A of tenant Ta outputs a deployment request to the virtual system manager 4A at time of day tn. A deployment request is a request to deploy application program App1 and the permissible time is shorter than 6.0 min.

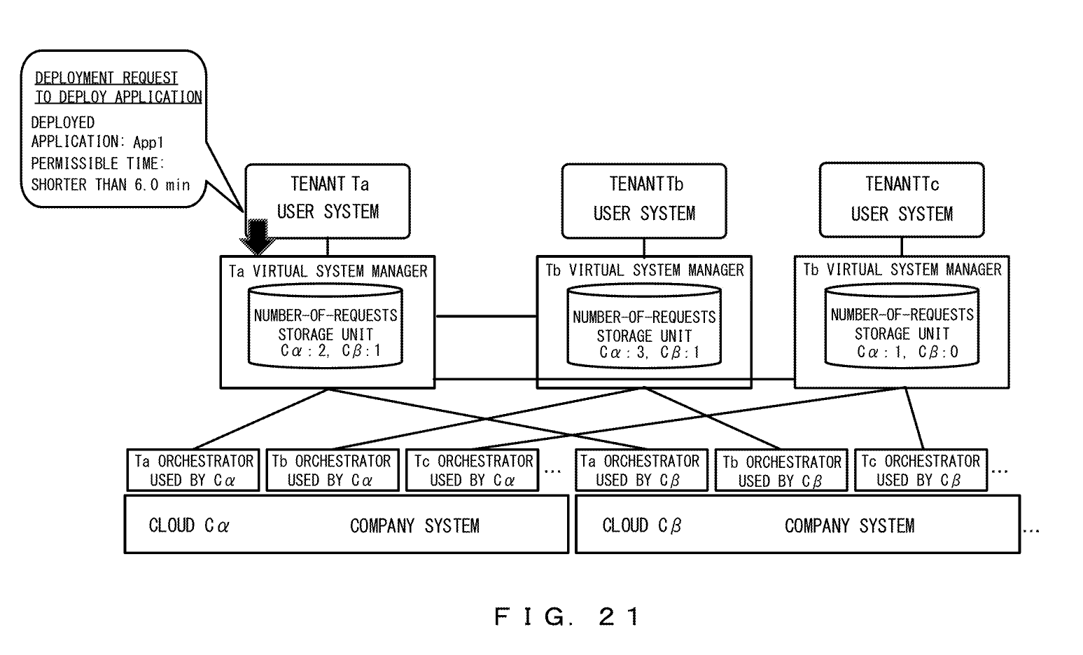

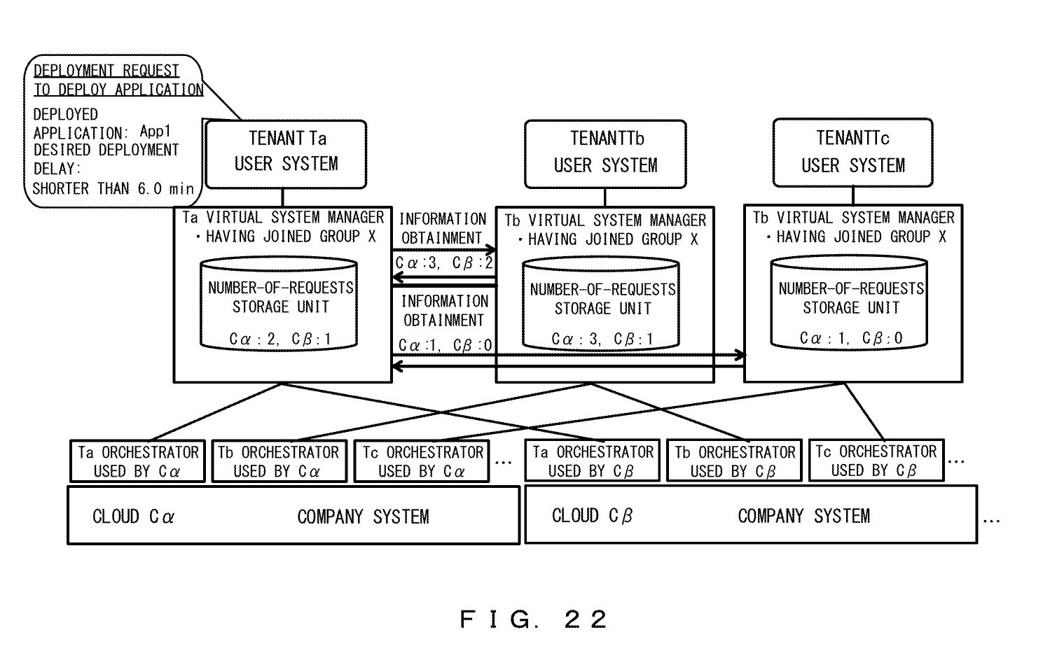

As illustrated in the example in FIG. 21, the request reception unit 13 of the virtual system manager 4A receives a deployment request. In step S12 in FIG. 12, the information obtainment unit 14 obtains the number of deployment requests in the current time range from the number-of-requests storage units 24 of all the virtual system managers 4 in the same group. FIG. 22 illustrates an example of obtaining the number of deployment requests.

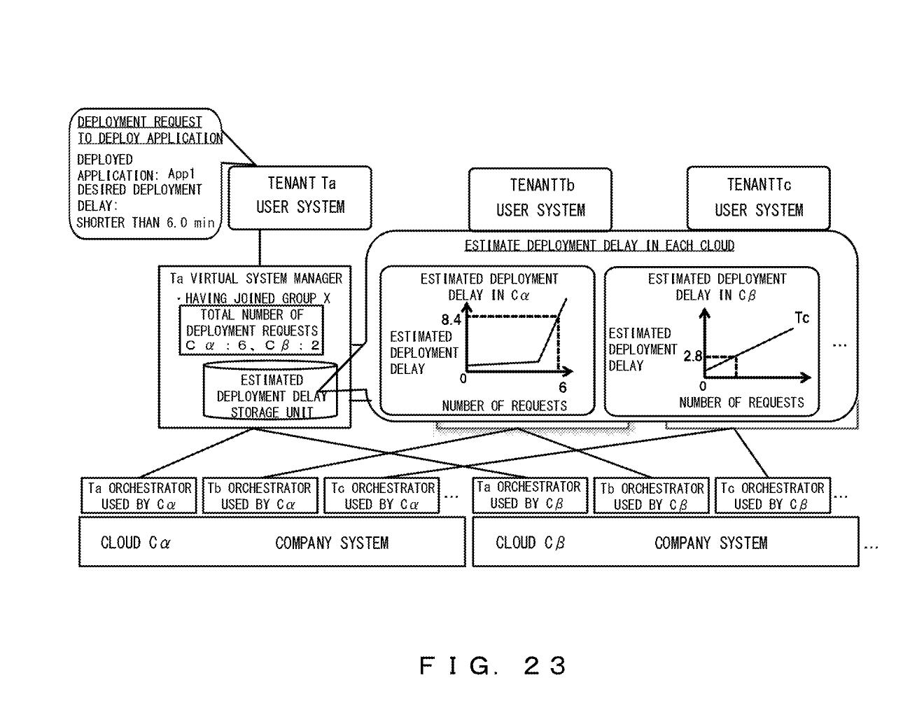

In step S13, the deployment destination selection unit 17 calculates, from the obtained number of deployment requests, the total number of deployment requests in the current time range for each cloud. In the case of the example illustrated in FIG. 23, the total number of deployment requests to cloud Cain the current time range is 6 (=2+3+1). Also, the total number of determination results to cloud Cβ in the current time range is 2(=1+1+0).

In step S14, the deployment destination selection unit 17 estimates the deployment delay for each cloud on the basis of the total number of deployment requests and the estimated deployment delay. Regarding cloud Cα stored in the estimated deployment delay storage unit 21, the deployment destination selection unit 17 refers to the estimated deployment delay when the number of deployment requests is 6.

As illustrated in the example in FIG. 23, the deployment destination selection unit 17 recognizes from the estimated deployment delay storage unit 21 that the estimated deployment delay is 8.4. regarding cloud Cα when the number of deployment requests is six. In such a case, the estimated deployment delay (8.4) is longer than the permissible time (6.0). Accordingly, the deployment destination selection unit 17 excludes cloud Cα from the deployment destination candidates in step S15.

The deployment destination selection unit 17 recognizes from the estimated deployment delay storage unit 21 that the estimated deployment delay is 2.8. regarding cloud Cβ when the number of deployment requests is 2. In such a case, the estimated deployment delay (2.8) is shorter than the permissible time (6.0). Accordingly, the deployment destination selection unit 17 does not exclude cloud Cβ from the deployment destination candidates in step S15.

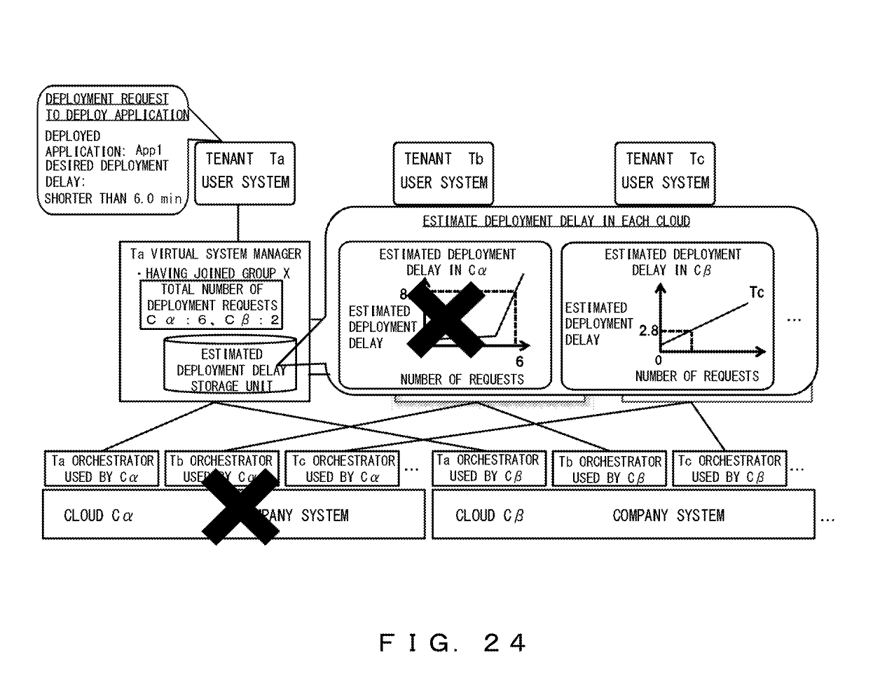

FIG. 24 illustrates an example in which the deployment destination selection unit 17 excludes cloud Cα from the deployment destination candidates while not excluding cloud Cβ. Because cloud Cα has been excluded from the deployment destination candidates, the deployment destination selection unit 17 determines in step S16 that there are not a plurality of deployment destination candidates.

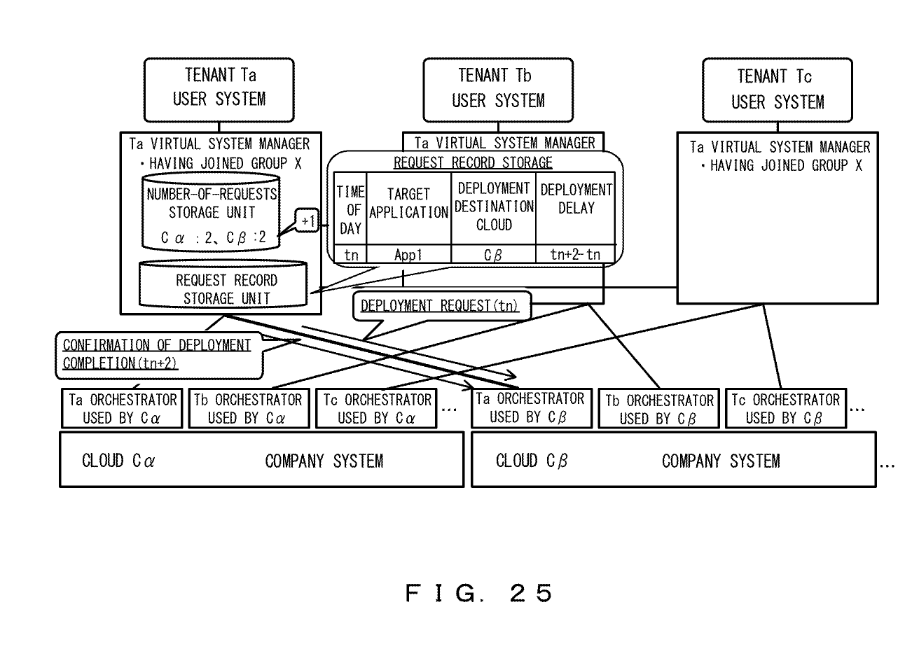

In step S17, the deployment destination selection unit 17 selects cloud Cβ, which is a deployment destination candidate. FIG. 25 illustrates an example in which the deployment requesting unit 18 output a deployment request to cloud Cβ.

In step S21 of FIG. 13, to the orchestrator 5 of cloud Cα (Ta orchestrator used by Cβ), the deployment requesting unit 18 outputs a deployment request to deploy application program App1 to cloud Cβ, which is the deployment destination selected by the deployment destination selection unit 17.

In step S22, the deployment requesting unit 18 increments the number of deployment requests to cloud Cβ in the current time range. Thus, the number of deployment requests corresponding to cloud Cβ in the number-of-requests storage unit 24 becomes two.

The configuration conversion unit 32 of the Ta orchestrator 5 used by Cβ converts an input deployment request on the basis of the conversion rule stored in the conversion rule storage unit 33. On the basis of the deployment request after being converted, the deployment request control unit 34 makes a request for cloud Cβ to deploy application program App1 Cloud Cβ deploys application program App1.

In step S23, the virtual system manager 4A accesses cloud Cβ and treats, as tn+2, the time of day at which the completion of the deployment of application program App1 has been recognized. In step S24, the deployment requesting unit 18 treats, as the deployment delay (2=tn+2−tn), a value obtained by subtracting time of day to from time of day tn+2, and stores the deployment delay in the request record storage unit 23.

Through the above processes, the virtual system manager 4A outputs to cloud Cβ the deployment request output from the user system 3A. Cloud Cβ deploys application program App1 on the basis of the deployment request.

Accordingly, virtual system manager 4A selects cloud Cβ, in which application program App1 can be deployed within the permissible time set by the user system 3A, and outputs a deployment request to cloud Cβ. This makes it possible for cloud Cβ to deploy application program App1 with a deployment delay shorter than the permissible time.

In this situation, the virtual system manager 4A can select a cloud in which an application program can be deployed within a permissible time without obtaining information related to the states of the respective clouds from those clouds.

The embodiment makes it possible to estimate a time taken to deploy a function, by using information on the user side.

### Variation Example

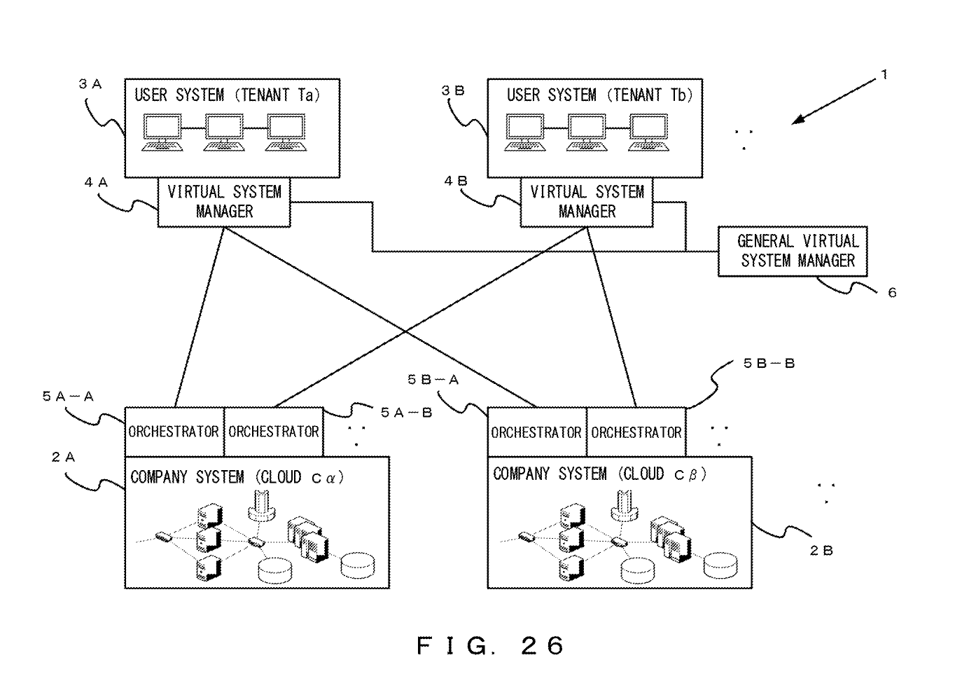

Next, a variation example will be explained. FIG. 26 illustrates an example of the system 1 in a variation example. In a variation example, a general virtual system manager 6 is added to the system 1 illustrated in FIG. 1 in the above embodiment. In the variation example, the general virtual system manager 6 is an example of a first computer, and each virtual system manager 4 is an example of a second computer.

The virtual system manager 4 corresponding to each user system 3 is connected to the general virtual system manager 6. The general virtual system manager 6 is a computer obtained by integrating some of the functions of the virtual system managers 4 in the embodiment.

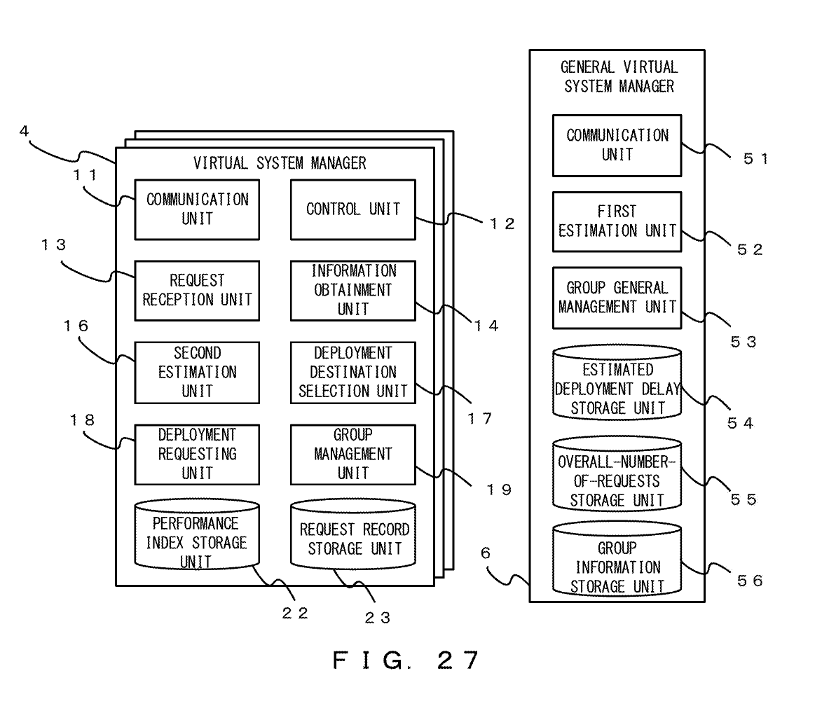

FIG. 27 illustrates an example of the virtual system manager 4 and the general virtual system manager 6. The virtual system manager 4 in the variation example does not include the first estimation unit 15, the estimated deployment delay storage unit 21, the number-of-requests storage unit 24, or the group information storage unit 25, which is included in the virtual system manager 4 illustrated in FIG. 2 in the embodiment.

The general virtual system manager 6 includes a communication unit 51, a first estimation unit 52, a group general management unit 53, an estimated deployment delay storage unit 54, an overall number-of-requests storage unit 55, and a group information storage unit 56. The communication unit 51 communicates with the respective virtual system managers 4.

The first estimation unit 52 is equivalent to the first estimation unit 15 of each virtual system manager 4 in the embodiment. The group general management unit 53 manages, in a general manner, information related to at least one group to which the respective virtual system managers 4 belong.

The estimated deployment delay storage unit 54 is equivalent to the estimated deployment delay storage unit 21 of each virtual system manager 4 in the embodiment. The overall number-of-requests storage unit 55 stores, for each cloud, the number of deployment requests output from the respective virtual system managers 4 in the current time range. The group information storage unit 56 is equivalent to the group information storage unit 25 of the virtual system manager 4 in the embodiment.

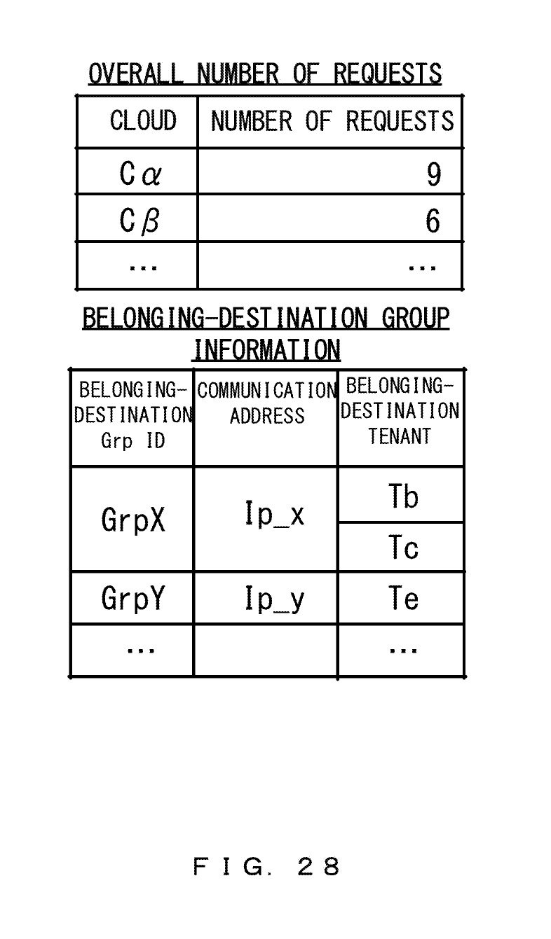

FIG. 28 illustrates an example of a table in the variation example. FIG. 28 illustrates an example of a table stored by the overall number-of-requests storage unit 55 and a table stored by the group information storage unit 56.

The overall number-of-requests storage unit 55 stores, for each cloud, the total number of deployment requests output from the respective virtual system managers 4 in the current time range. Similarly to the above embodiment, information stored by the overall number-of-requests storage unit 55 is reset each time the time range changes.

The group information storage unit 56 stores belonging-destination group IDs, communication addresses and belonging-destination tenants for at least one group. FIG. 28 illustrates an example in which tenants Tb and Tc belong to group X and tenant Te belongs to group Y. Communication address Ip_X is assigned to group X and communication address Ip_Y is assigned to group Y.

Next, processes in the variation example will be explained. A group-joining process in the variation example is similar to the processes in the flowchart illustrated in FIG. 8. Also, the deployment delay estimation process in the variation example is similar to the processes in the flowchart illustrated in FIG. 9. However, the deployment delay estimation process in the variation example is performed by the general virtual system manager 6.

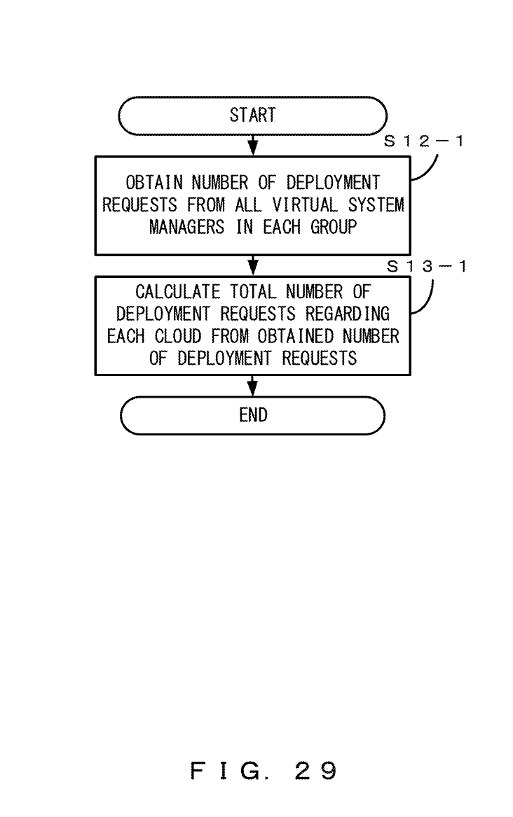

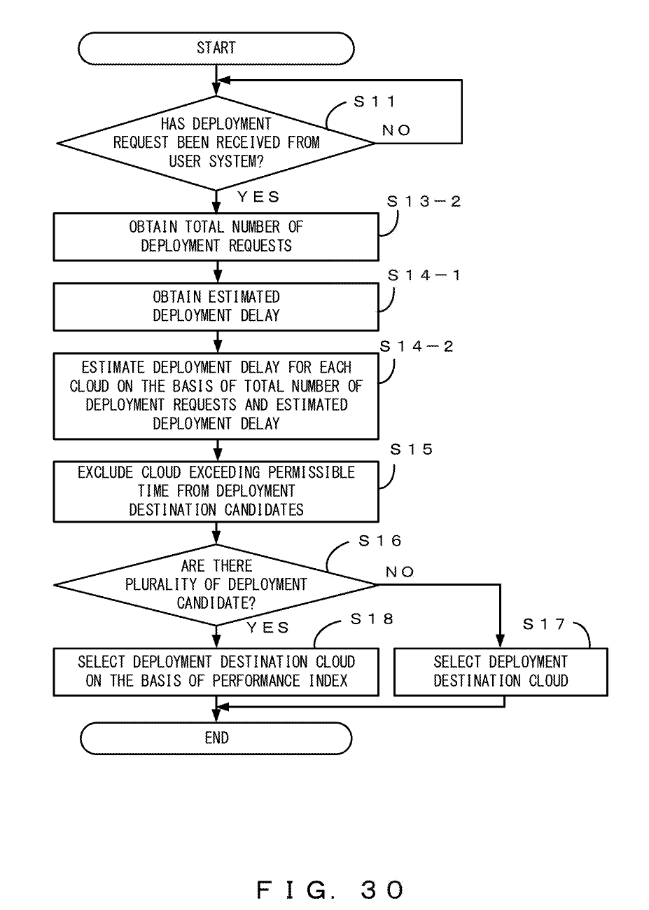

By referring to FIG. 29 and FIG. 30, the cloud selection process in the variation example will be explained. FIG. 29 illustrates an example of a process performed by the general virtual system manager 6 among the cloud selection processes in the variation example.

The general virtual system manager 6 obtains the number of deployment requests in the current time range from all the virtual system managers 4 in each group (step S12-1). Also, the general virtual system manager 6 calculates the total number of deployment requests to each cloud from the obtained number of deployment requests (step S13-1). Then, the general virtual system manager 6 stores the calculated number of deployment requests in the overall number-of-requests storage unit 55 for each cloud.

FIG. 30 illustrates an example of a process performed by the virtual system manager 4 among the cloud selection processes in the variation example. Among the processes illustrated in FIG. 30, the processes other than those in steps S13-2, S14-1 and S14-2 are similar to the processes in the corresponding steps in FIG. 12.

The information obtainment unit 14 of the virtual system manager 4 obtains the total number of deployment requests in the current time range from the overall number-of-requests storage unit 55 of the general virtual system manager 6 (step S13-2). Also, the information obtainment unit 14 of the virtual system manager 4 obtains the estimated deployment delay stored in the estimated deployment delay storage unit 54 (step S14-1).

Then, the second estimation unit 16 of the virtual system manager 4 estimates the deployment delay for each cloud (step S14-2) on the basis of the total number of deployment requests calculated in step S13 and the estimated deployment delay obtained in step S14-1.

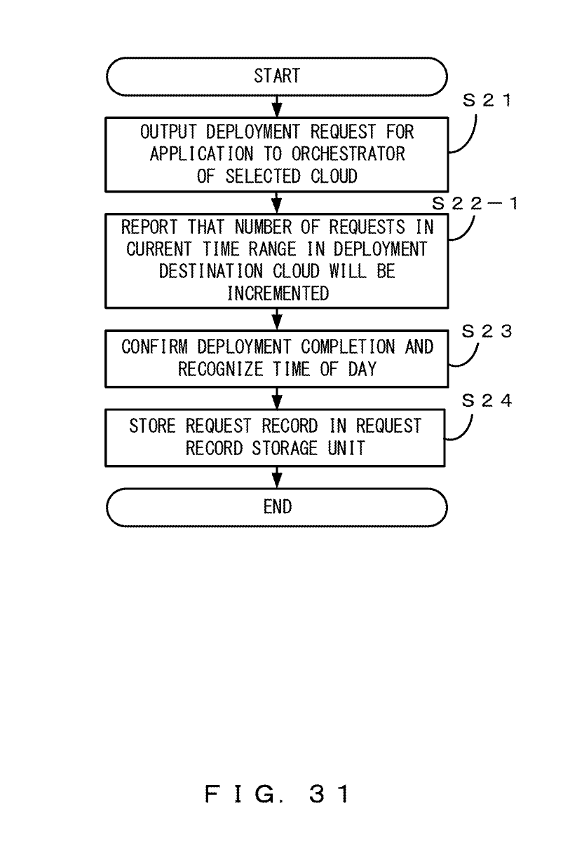

By referring to FIG. 31, explanations will be given for the deployment requesting process in the variation example. The deployment requesting process in the variation example is different from the deployment requesting process illustrated in FIG. 12 in the process in step S22. The deployment requesting unit 18 of the virtual system manager 4 outputs a deployment request to the orchestrator 5 in step S21.

Thereafter, the deployment requesting unit 18 outputs to the general virtual system manager 6 a report that the number of requests in the current time range to the deployment destination cloud will be incremented (step S22-1). The general virtual system manager 6 updates the information of the overall number-of-requests storage unit 55 on the basis of the input report.

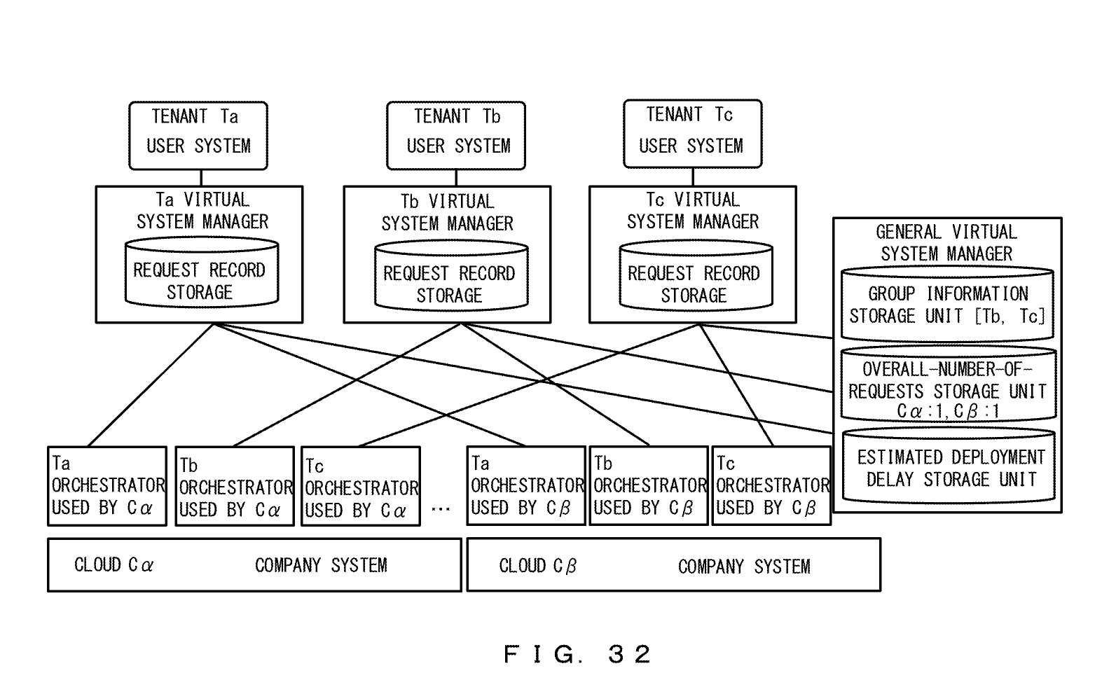

By referring to FIG. 32 through FIG. 38, explanations will be given for a specific example of the variation example. FIG. 32 illustrates an example of the system 1 including the virtual system managers 4 respectively for tenants Ta, Tb and Tc, and the general virtual system manager 6.

Each virtual system manager 4 is connected to the general virtual system manager 6. In the example illustrated in FIG. 32, the group information storage unit 56 of the general virtual system manager 6 stores that the Tb virtual system manager 4 and the Tc virtual system manager 4 belong to the group X.

Also, the overall number-of-requests storage unit 55 represents that one deployment request has been output to cloud Ca and one deployment request has been output to cloud Cβ in the current time range. Also, the estimated deployment delay storage unit 54 stores an estimated deployment delay in response to the number of deployment requests.

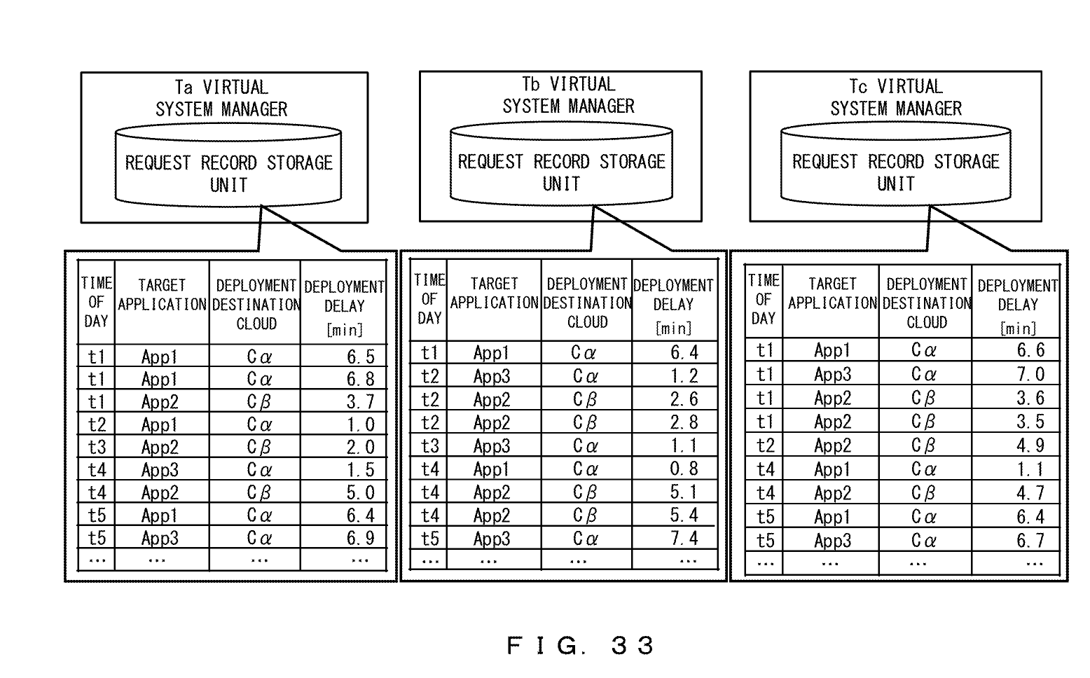

As illustrated in the example in FIG. 33, the request record storage units 23 of the virtual system managers 4 for tenants Ta, Tb and Tc respectively store request records. Each time the virtual system manager 4 outputs a deployment request to the orchestrator 5, a request record is stored in the request record storage unit 23.

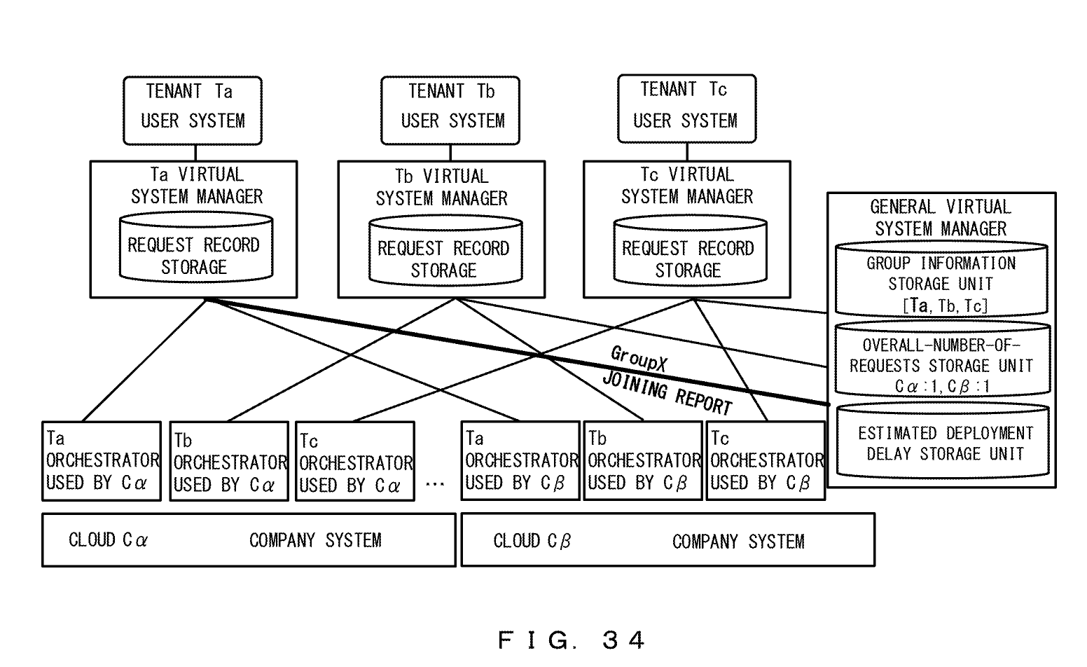

It is assumed in this situation that Ta virtual system manager has output to the general virtual system manager 6 a report indicating the joining in group X as illustrated in the example in FIG. 34. The group general management unit 53 of the general virtual system manager 6 stores, in the group information storage unit 56, information indicating that Ta virtual system manager will belong to group X. Thereby, the Ta virtual system manager belongs to group X.

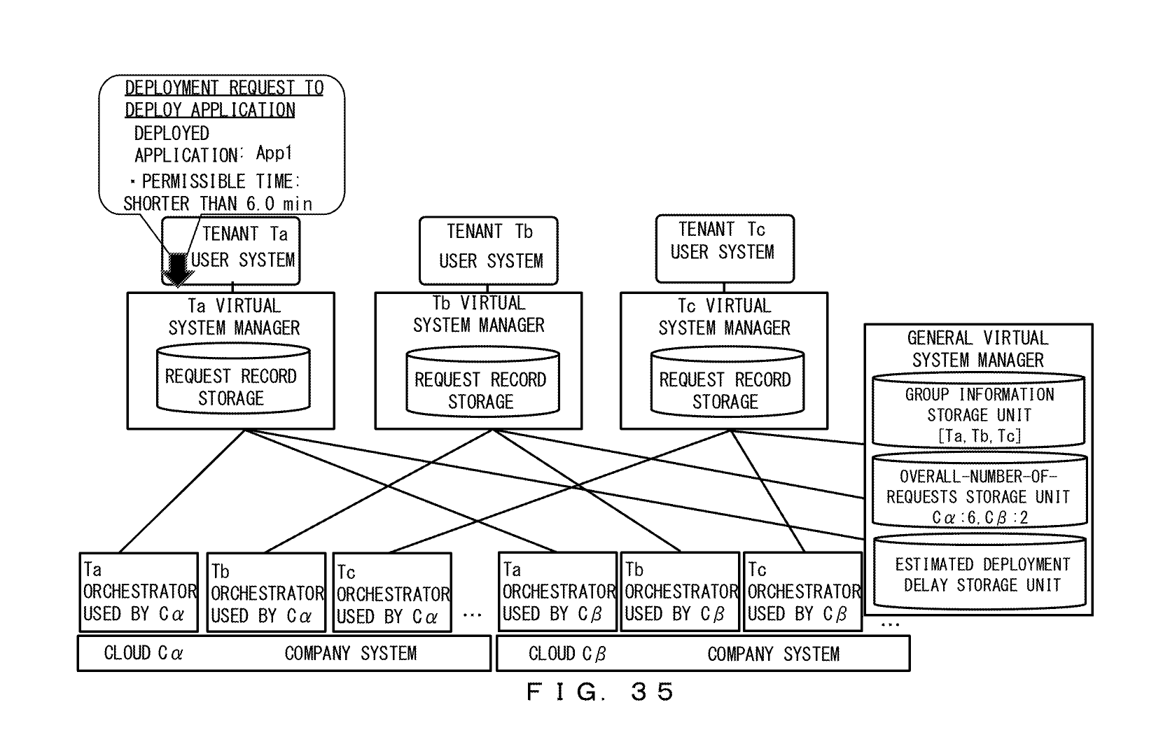

Next, as illustrated in the example in FIG. 35, it is assumed that the user system 3A of tenant Ta outputs, to the Ta virtual system manager, a deployment request to deploy application program App1. The permissible time is assumed to be shorter than 6.0 min.

It is assumed that six deployment requests have been output to cloud Cα and two deployment requests have been output to cloud Cβ in the time range in which Ta virtual system manager outputs deployment requests. The overall number-of-requests storage unit 55 stores this information.

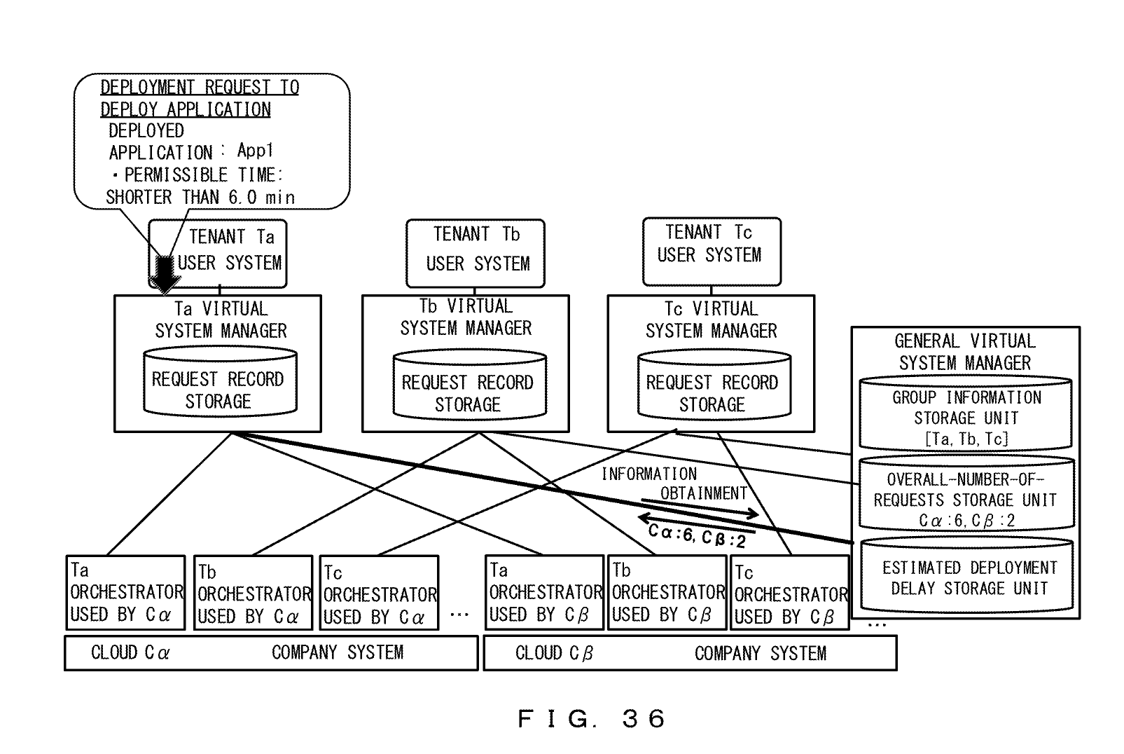

As illustrated in the example in FIG. 36, the information obtainment unit 14 of the Ta virtual system manager obtains the information stored in the overall number-of-requests storage unit 55 of the general virtual system manager 6. Thereby, the Ta virtual system manager recognizes that six deployment requests have been output to cloud Cα and two deployment requests have been output to cloud Cβ.

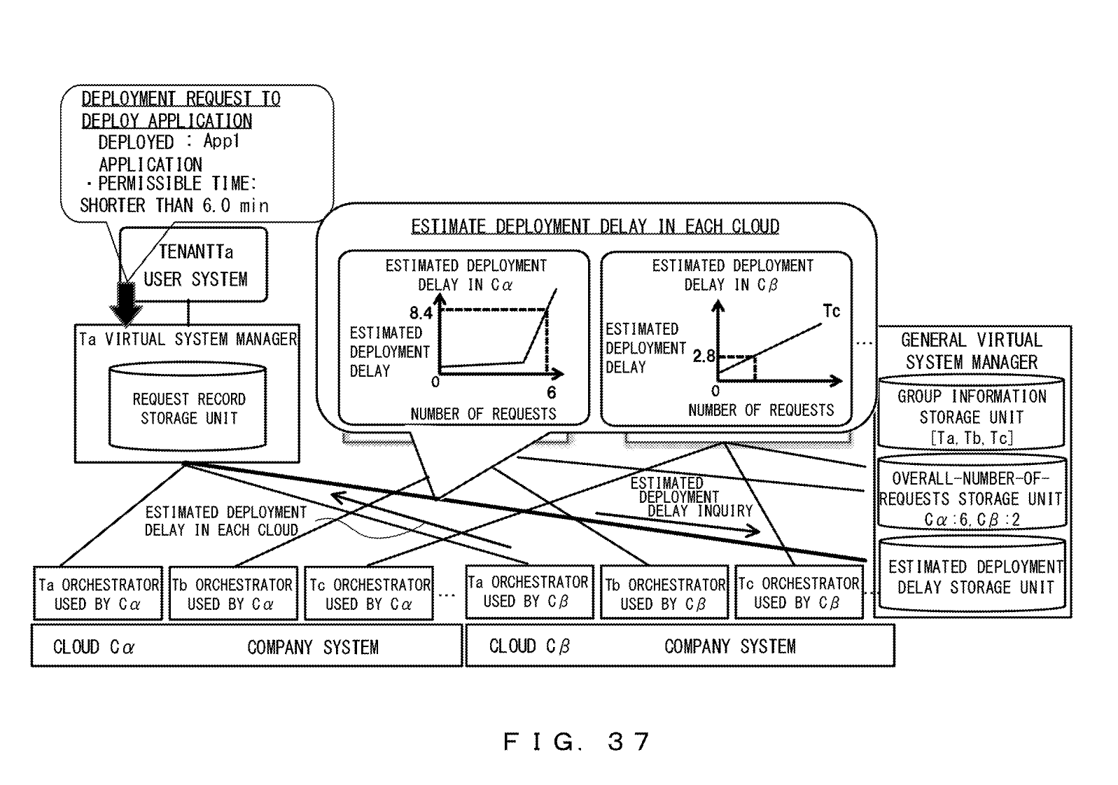

As illustrated in the example in FIG. 37, the Ta virtual system manager has made an inquiry about an estimated deployment delay to the general virtual system manager 6. The first estimation unit 52 of the general virtual system manager 6 estimates the deployment delay in accordance with the number of deployment requests for each cloud, and stores in the estimated deployment delay storage unit 54 the estimation result as the estimated deployment delay.

Accordingly, in response to the inquiry from the Ta virtual system manager, the general virtual system manager 6 reads the estimated deployment delay from the estimated deployment delay storage unit 54 so as to output it to the Ta virtual system manager 4.

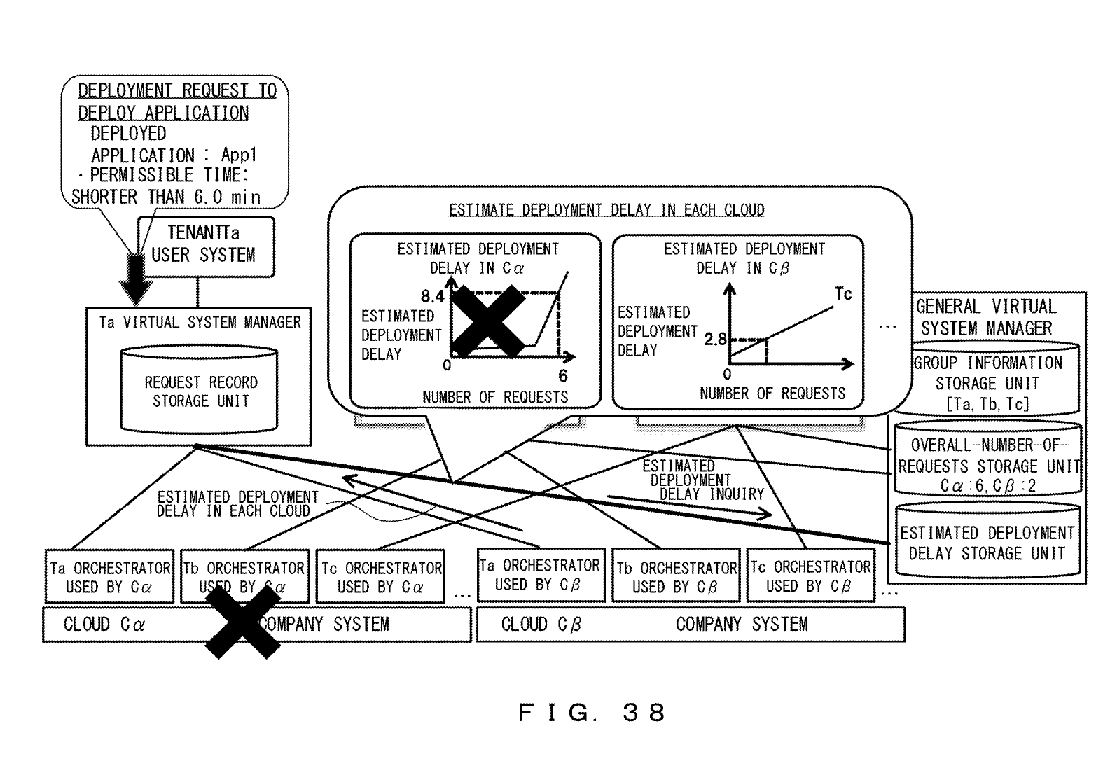

The deployment destination selection unit 17 of the Ta virtual system manager excludes cloud Cα from deployment destination candidates as illustrated in the example in FIG. 38 because the permissible time for the deployment request input from the user system 3A of tenant Ta is shorter than 6.0 min.

It is assumed that a deployment destination candidate after the exclusion conducted by the deployment destination selection unit 17 is a candidate in cloud Cα. The deployment destination selection unit 17 selects cloud Cβ as the deployment destination of application program App1 on the basis of the deployment request received from the user system 3A of tenant Ta.

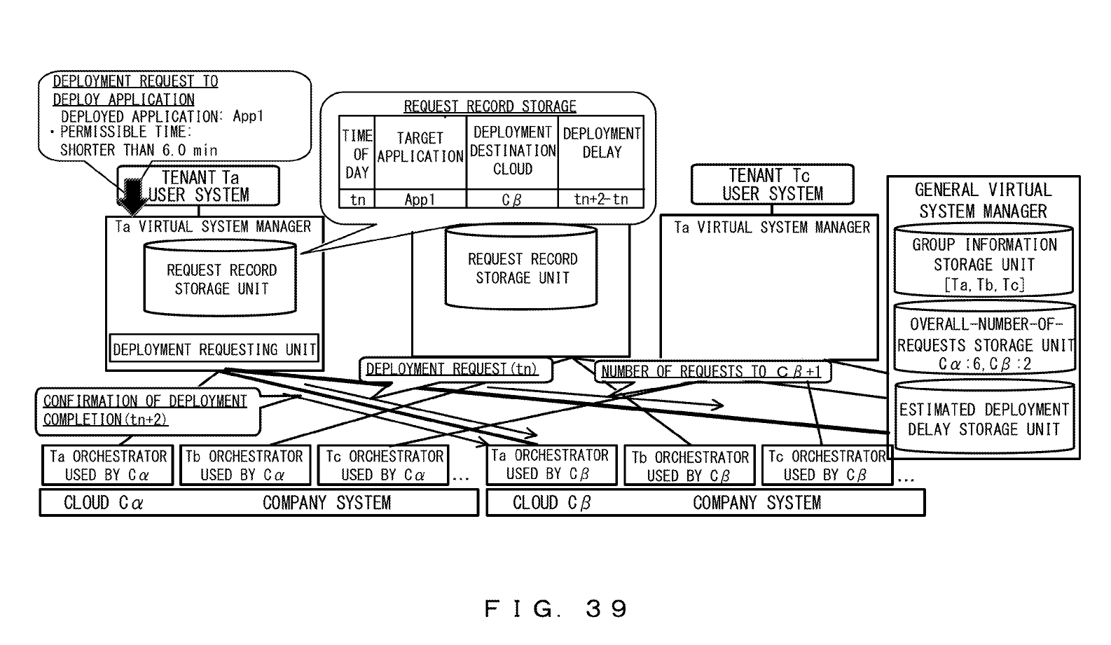

As illustrated in the example in FIG. 39, at time of day Tn, the deployment requesting unit 18 of the Ta virtual system manager outputs to cloud Cβ a deployment request to deploy application program App1. Cloud Cβ deploys application program App1.

The Ta virtual system manager confirms the time of day at which the deployment of application program App1 has been completed by cloud Cβ. The time of day at which cloud Cβ has completed the deployment of application program App1 is assumed to be tn+2.

The control unit 12 of the Ta virtual system manager subtracts tn from tn+2, tn being the time of day at which the deployment request was output and tn+2 being the time of day at which the completion of the deployment was confirmed. The control unit 12 stores the subtraction result, i.e., (2=tn+2−tn) in the request record storage unit 23 as the deployment delay.

Also, in the current time range (the time range of time of day tn), the Ta virtual system manager has output a deployment request to cloud Cβ. Accordingly, the control unit 12 outputs to the general virtual system manager 6 a report that the number of deployment requests to cloud Cβ in the current time range has increased by one.

The general virtual system manager 6 increments the total number of deployment requests to cloud Cβ in the current time range stored in the overall number-of-requests storage unit 55.

In the variation example, the general virtual system manager 6 implements some of the functions of the virtual system managers 4 of the above embodiment. This makes it possible for the virtual system managers 4 in the variation example to omit some of the functions described above.

In the system 1 of the variation example, the general virtual system manager 6 is provided in addition to the virtual system managers 4. This eliminates the necessity of providing a separate computer, differently from the system 1 described in the above embodiment.

### <Example of Hardware Configuration of Virtual System Manager>

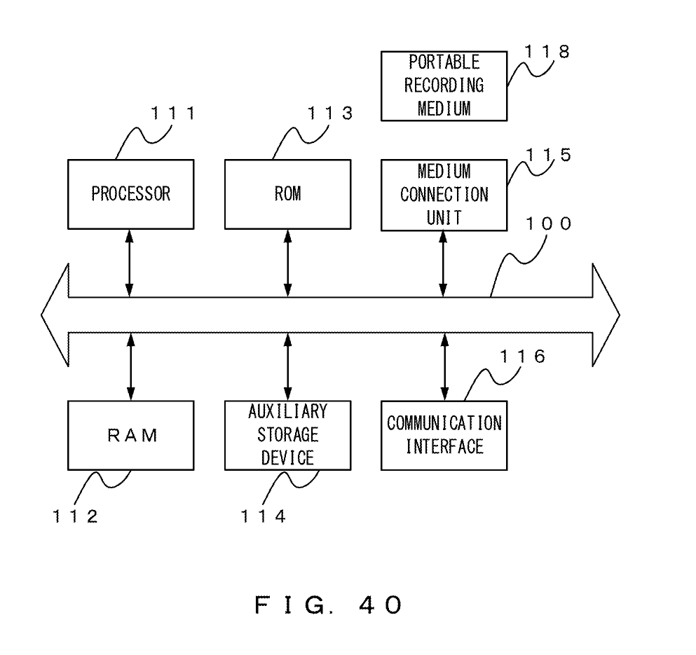

Next, by referring to the example in FIG. 40, an example of a hardware configuration of the virtual system manager 4 will be explained. As illustrated in the example in FIG. 40, a processor 111, a RAM 112, a ROM 113, an auxiliary storage device 114, a medium connection unit 115, and a communication interface 116 are connected to a bus 100.

The processor 111 is an arbitrary processing circuit. The processor 111 executes a program developed in the RAM 112. As a program to be executed, a program that executes the processes in the embodiment may be used. The ROM 113 is a non-volatile storage device that stores a program developed in the RAM 112.

The auxiliary storage device 114 is a storage device that stores various types of information. A hard disk drive, a semiconductor memory etc. for example may be used as the auxiliary storage device 114. The medium connection unit 115 is provided in such a manner that it can be connected to a portable recording medium 118.

As a portable memory, an optical disk (such as for example a Compact Disk (CD), a Digital Versatile Disk (DVD), a semiconductor memory, etc.) for example may be used as the portable recording medium 118. It is also possible for the portable recording medium 118 to record a program for executing the processes in the embodiment.

The communication unit 11 of the virtual system manager 4 may be implemented by the communication interface 116. Each storage unit may be implemented by the RAM 112, the auxiliary storage device 114, etc. The other units may be implemented by the processor 111.

Each of the RAM 112, the ROM 113, the auxiliary storage device 114, and the portable recording medium 118 is an example of a computer-readable tangible storage medium. These tangible storage media are not transitory medium such as signal carrier waves.

### <Example of Hardware Configuration of General Virtual System Manager>

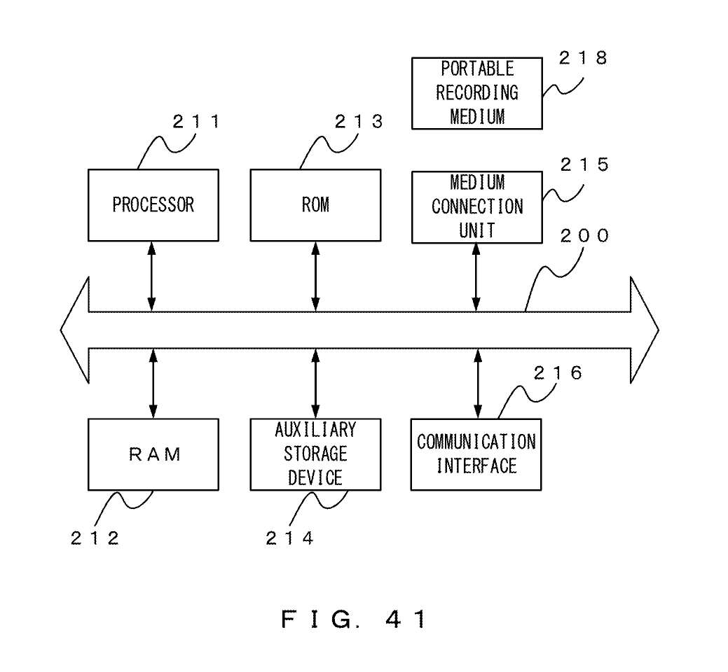

Next, by referring to the example illustrated in FIG. 41, an example of a hardware configuration of the general virtual system manager 6 will be explained. As illustrated in the example in FIG. 41, a processor 211, a RAM 212, a ROM 213, an auxiliary storage device 214, a medium connection unit 215 and a communication interface 216 are connected to a bus 200.

The respective units in the example in FIG. 41 are similar to those in the example in FIG. 40. The communication unit 51 may be implemented by the communication interface 216. The respective storage units may be implemented by the RAM 212, the auxiliary storage device 214, etc. The first estimation unit 52 may be implemented by the processor 211.

Each of the RAM 212, the ROM 213, the auxiliary storage device 214 and a portable recording medium 218 is an example of a computer-readable tangible storage medium. These tangible storage media are not transitory medium such as signal carrier waves.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A deployment control method comprising:
obtaining, from a storage corresponding to a user system, record information containing a deployment time that was taken for an information processing system to deploy a function corresponding to a deployment request output from the user system and a time of day at which the deployment request was output;
calculating a number of deployment requests for each prescribed period of time on the basis of the time of day and the deployment request; and
estimating a time taken to deploy the function in response to the number of deployment requests per the prescribed period of time on the basis of the deployment times of the pieces of record information aggregated for each of the numbers of deployment requests.

2. The deployment control method according to claim 1, wherein
in the estimating, a statistical process is conducted on the deployment times of the aggregated pieces of record information and a value obtained by the statistical process is estimated to be the time taken to deploy the function.

3. The deployment control method according to claim 1, wherein
in the estimating, a time longer than an average time of the deployment times of the aggregated pieces of record information is estimated to be the time taken to deploy the function.

4. The deployment control method according to claim 1, wherein
in the estimating, a time longest among the deployment times of the aggregated pieces of record information is estimated to be the time taken to deploy the function.

5. The deployment control method according to claim 1, wherein
when record information corresponding to the number of deployment requests does not exist, a time taken to deploy the function in response to the number of deployment requests for which the record information does not exist is complemented on the basis of an estimated time taken to deploy the function in response to a different number of deployment requests.

6. The deployment control method according to claim 1, wherein
in the obtaining, the record information is obtained from a storage corresponding to each of the plurality of user systems.

7. The deployment control method according to claim 1, wherein
the record information contains the deployment times of deployment requests to the plurality of information processing systems and the times of day,
in the calculating, the number of deployment requests is calculated for each of the prescribed times regarding each of the plurality of information processing systems, and
in the estimating, a time taken to deploy the function is estimated regarding each of the plurality of information processing systems.

8. The deployment control method according to claim 7, wherein
the number of deployment requests of the plurality of user systems in a time range corresponding to a time of day at which the deployment request was received is obtained,
an information processing system in response to the deployment request is selected from among the plurality of information processing systems, on the basis of a total number of deployment requests obtained by adding the deployment requests and an estimated time taken to deploy the function, and
the deployment request is output to the selected information processing system.

9. The deployment control method according to claim 8, wherein
when the deployment request contains a permissible time, an information processing system for which an estimated time taken to deploy the function exceeds the permissible time is excluded from a selection target scope.

10. The deployment control method according to claim 9, wherein
when the selection target scope includes a plurality of information processing systems, an information processing system having a highest processing speed for deploying the function is selected.

11. The deployment control method according to claim 9, wherein
an information processing system in response to the deployment request is selected on the basis of a processing speed for deploying the function and cost of each information processing system when the selection target scope includes a plurality of information processing systems.

12. A deployment control method comprising:
obtaining, by using a first computer and from storages corresponding to a plurality of user systems, record information containing a deployment time that was taken for a plurality of information processing systems to deploy a function corresponding to a deployment request output from each of the plurality of user systems and a time of day at which the deployment request was output;
calculating, by using the first computer, a number of deployment requests for each prescribed period of time on the basis of the time of day and the deployment request regarding each of the plurality of information processing systems;
estimating, by using the first computer, a time taken to deploy the function in response to the number of deployment requests per the prescribed period of time regarding each of the plurality of information processing systems on the basis of the deployment times of the pieces of record information aggregated for each of the numbers of deployment requests;
obtaining, by using the first computer, the number of deployment requests of the plurality of user systems in a time range corresponding to a time of day at which the deployment request was received;
selecting, by using a second computer, an information processing system in response to the deployment request from among the plurality of information processing systems on the basis of a total number of deployment requests obtained by adding the deployment requests and on the basis of an estimated time taken to deploy the function; and
outputting, by using the second computer, the deployment request to the selected information processing system.

13. A computer-readable recoding medium having stored therein a deployment control program for causing a computer to execute a process comprising:
obtaining, from a storage corresponding to a user system, record information containing a deployment time that was taken for an information processing system to deploy a function corresponding to a deployment request output from the user system and a time of day at which the deployment request was output;
calculating number of deployment requests for each prescribed period of time on the basis of the time of day and the deployment request; and
estimating a time taken to deploy the function in response to number of deployment requests per the prescribed period of time on the basis of the deployment times of the pieces of record information aggregated for each of the numbers of deployment requests.

14. A deployment control device comprising a processor that
obtains, from a storage corresponding to a user system, record information containing a deployment time that was taken for an information processing system to deploy a function corresponding to a deployment request output from the user system and a time of day at which the deployment request was output, and
calculates number of deployment requests for each prescribed period of time on the basis of the time of day and the deployment request and estimates a time taken to deploy the function in response to number of deployment requests per the prescribed period of time on the basis of the deployment times of the pieces of record information aggregated for each of the numbers of deployment requests.
